(19) United States
(12) Patent Application Publication
(10) Pub. No.: US 2026/0225849 A1
(43) Pub. Date: Aug. 6, 2026

(54) DATA CABLE DEVICE

(71) Applicant: Shenzhen Baseus Technology Co., Ltd, Shenzhen (CN)

(72) Inventors: SHI-YOU HE, Shenzhen (CN); GUANG-BIN LI, Shenzhen (CN)

(21) Appl. No.: 19/634,784

(22) Filed: Mar. 31, 2026

Related U.S. Application Data
(63) Continuation-in-part of application No. PCT/CN2025/103607, filed on Jun. 25, 2025.

(30) Foreign Application Priority Data
Jun. 25, 2024 (CN) 202421467835.3
Jun. 25, 2024 (CN) 202421470089.3
Aug. 6, 2024 (CN) 202421901068.2

(51) Int. Cl. B65H 75/48; B65H 75/44

(52) U.S. Cl. CPC B65H 75/486; B65H 75/4418; B65H 2701/32

(57) ABSTRACT

Provided in the present disclosure is a data cable device. The data cable device includes a housing, a rotating member, a cable coiled on the rotating member, a first elastic member arranged between the rotating member and the housing; and a limiting assembly, which comprises: a first limiting member arranged at one end of the rotating member, at least one first groove being formed on the peripheral side of the first limiting member; a second limiting member rotatably disposed on the housing, an end surface of the second limiting member being further provided with a second protrusion and a third protrusion which are spaced apart from each other; a third limiting member rotatably disposed on the housing and located between the second protrusion and the third protrusion; and an elastic assembly arranged between the second limiting member and the housing.

### CROSS-REFERENCE TO RELATED APPLICATIONS

The present disclosure claims the benefit of and priority to Chinese patent application NO. 202421467835.3, filed on June 25, 2024, entitled “a data cable device”, in China National Intellectual Property Administration, Chinese patent application NO. 202421470089.3, filed on June 25, 2024, entitled “an ultra-thin data cable storage device”, in China National Intellectual Property Administration, Chinese patent application NO. 202421901068.2, filed on August 6, 2024, entitled “a cable winder with multi-positioning”, in China National Intellectual Property Administration, the entirety of which is incorporated herein by reference.

### FIELD

The present disclosure relates to the field of data line technology, and in particular relates to a data cable device.

### BACKGROUND

In general, a data cable device is used to store cables. In related technologies, the data cable device includes a housing, a rotating structure, and a cable. The cable may be stored inside the housing or extended outside the housing via the rotating structure. When the cable in the data line storage structure is at a suitable length, a set of structures prevents the rotating structure from rotating in the cable retraction direction, resulting in poor stability of the cable at the suitable length.

Therefore, improvement is desired.

### SUMMARY

The embodiments of the present disclosure provide a data cable device. The technical solution of the present disclosure is implemented as follows:

The data cable device of the present disclosure includes a housing, a rotating member, a cable, a first elastic member, a limiting assembly and an elastic assembly; the housing includes an accommodating space and an opening communicating with the accommodating space, the rotating member is rotatably disposed within the accommodating space, a portion of the cable is coiled outside the rotating member and is capable of extending outward from the housing via the opening; the first elastic member is disposed between the rotating member and the housing, and the first elastic member is configured to provide a force to the rotating member to rotate in a retraction direction; and a limiting assembly includes a first limiting member, a second limiting member, a third limiting member and an elastic assembly; the first limiting member is disposed at one end of the rotating member, the first limiting member defines at least one first groove on a periphery of the first limiting member; the second limiting member is rotatably disposed in the housing; a periphery side of the second limiting member having a first protrusion for cooperating with the first groove, an end surface of the second limiting member includes a second protrusion and a third protrusion disposed at intervals; the third limiting member is rotatably disposed on the housing and the third limiting member is located between the second protrusion and the third protrusion, a peripheral of the third limiting member having at least one set of mating structures for cooperating with the second protrusion and the third protrusion, the second limiting member is configured to push the third limiting member to rotate through the mating structure; and the elastic assembly is disposed between the second limiting member and the housing, wherein the elastic assembly is configured to provide a force to the second limiting member to position the first protrusion within the first groove, so as to cooperate with the mating structure to position the second limiting member in a positioned state where the first protrusion is within the first groove.

In an optional implementation, the data cable device further includes a stretched state and a retracted state; in the stretched state, the elastic assembly provides a force to the second limiting member to rotate in a first direction, and the first protrusion is located outside the first groove; in the retracted state, the elastic assembly provides a force to the second limiting member to rotate in a second direction, and the first protrusion is located outside the first groove; in the positioned state, the elastic assembly provides a force to the second limiting member to rotate in the second direction, and the first protrusion is located inside the first groove, wherein the second direction is opposite to the first direction, and the second direction is the same as the retraction direction.

In an optional implementation, the elastic assembly includes a second elastic member and a third elastic member; the second elastic member is configured to provide a force to the second limiting member to rotate in the second direction; the third elastic member is configured to provide a force to the second limiting member to rotate in the first direction.

In an optional implementation, the second elastic member and the third elastic member are disposed on the housing, the second elastic member and the third elastic member are located on opposite sides of the second limiting member, and the second elastic member and the third elastic member are respectively configured to contact the second limiting member.

In an optional implementation, a first end of the second elastic member is connected to the housing, and a second end of the second elastic member is configured to contact the second limiting member; a first end of the third elastic member is connected to the housing, and a second end of the third elastic member is configured to contact the second limiting member.

In an optional implementation, a peripheral of the second limiting member is provided with a first concave portion and a second concave portion that are oppositely arranged on its circumferential side, and the first concave portion and the second concave portion are arranged relative to each other; the second end of the second elastic member is located in the first concave portion, and the second end of the third elastic member is located in the second concave portion.

In an optional implementation, the second end of the second elastic member includes a first contact arc surface, and a first contact plane and a second contact plane located on both sides of the first contact arc surface, the second end of the third elastic member includes a second contact arc surface, and a third contact plane and a fourth contact plane located on both sides of the second contact arc surface.

In an optional implementation, the housing includes a first wall, the second limiting member and the third limiting member are disposed on the first wall, and the second elastic member and the third elastic member are respectively connected to one side of the first wall facing the accommodating space; on a projection plane parallel to a rotation axis, a projection area of the second elastic member and a projection area of the third elastic member are located outside a projection area of the first wall.

In an optional implementation, the first wall further defines a first slot and a second slot, the first slot communicates with the accommodating space and the first slot corresponds to a position of the second elastic member; the second slot communicates with the accommodating space and the second slot corresponds to a position of the third elastic member; on a projection plane perpendicular to the rotation axis, a contour line of the first slot is adjacent to a portion of a contour line of the second elastic member, and a contour line of the second slot is adjacent to a portion of a contour line of the third elastic member.

In an optional implementation, the first wall, the second elastic member, and the third elastic member are different parts of the same structural member; or the first wall, the second elastic member, and the third elastic member are different structural components.

In an optional implementation, the second limiting member includes a first structural portion and a second structural portion, the first structural portion is rotatably connected to the housing; the elastic assembly is disposed between the first structural portion and the housing; a first side of the second structural portion is connected to the first structural portion, a second side of the second structural portion has the first protrusion, and the second protrusion and the third protrusion are located on an end surface of the second structural portion.

In an optional implementation, a first portion of the first structural portion protrudes axially from the end surface of the second structural portion, and the third limiting member is located within a space defined by the first portion of the first structural portion, the second protrusion, and the third protrusion.

In an optional implementation, the second protrusion, the third protrusion, and the first portion of the first structural portion have the same or similar axial height.

In an optional implementation, the mating structure includes a first mating portion, a second mating portion, and a third mating portion arranged adjacent to each other along a circumference of the third limiting member; the first mating portion and the third mating portion are configured to cooperate with the second protrusion; the second mating portion is configured to cooperate with the third protrusion; wherein a distance between the first mating portion and an axis is smaller than a distance between the third mating portion and the axis; in the stretched state, the second mating portion engages with the third protrusion; in the positioned state, the second protrusion contacts the third mating portion; and in the retracted state, the second protrusion engages with the first mating portion.

In an optional implementation, the first mating portion includes a second groove, the second mating portion includes a first side surface, and the third mating portion includes a third groove; the second groove and the third groove are configured to cooperate with the second protrusion, the first side surface is configured to cooperate with a second side surface of the third protrusion; wherein a depth of the second groove is greater than a depth of the third groove; in a stretched state, the first side surface and the second side surface are arranged adjacent to each other; in a positioned state, the second protrusion is located in the third groove; and in the retracted state, the second protrusion is located in the second groove.

In an optional implementation, a peripheral side of the third limiting member further has a protrusion structure located between the second groove and the third groove, and the first side surface is located on one side of the protrusion structure facing the second groove.

In an optional implementation, the third limiting member has three sets of mating structures, and the three sets of mating structures are evenly distributed along a circumference of the third limiting member.

In an optional implementation, the second protrusion and the third protrusion have the same or similar axial height.

In an optional implementation, in a stretched state, the elastic assembly is configured to provide a force for the second limiting member to rotate in the first direction, so that the first protrusion is located within the first groove, and the mating structure is configured to cooperate with the second protrusion to position the second limiting member in the positioned state where the first protrusion is located in the first groove.

In an optional implementation, an axis of the third limiting member is parallel to an axis of the second limiting member, an end surface of the third limiting member is disposed adjacent to an end surface of the second limiting member, and the third limiting member and the second protrusion have the same or similar axial height.

In an optional implementation, an axial thickness of the third limiting member is uniformly distributed, and the mating structure is arranged along a circumference of the third limiting member.

In an optional implementation, a shape of an insertion end of the second protrusion matches a shape of the second groove, the end surface of the insertion end of the second protrusion is configured to contact a bottom surface of the second groove, a first included angle between two sides of the insertion end of the second protrusion is less than 45 degrees, a second included angle between two sides of the third groove is greater than 90 degrees, and the end surface of the insertion end of the second protrusion is configured to contact a side surface of the third groove.

In an optional implementation, the first included angle ranges from 39 degrees to 41 degrees, the second included angle ranges from 100 degrees to 105 degrees, and a third included angle between two sides of the second groove ranges from 40 degrees to 42 degrees.

In an optional implementation, the data cable device further has a retracted state; in the stretched state, the elastic assembly provides a force to the second limiting member to rotate in a first direction, and the first protrusion is located outside the first groove; in the retracted state, the elastic assembly provides a force to the second limiting member to rotate in a second direction, and the first protrusion is located outside the first groove; in the positioned state, the elastic assembly provides a force to the second limiting member to rotate in the second direction, and the first protrusion is located inside the first groove, and the second direction is opposite to the first direction, and the second direction is the same as a retraction direction.

In an optional implementation, the rotating member has a winding portion and a baffle portion in an axial direction, and the winding portion is adjacent to the baffle portion; wherein: a portion of the cable is coiled outside the winding portion and the portion of the cable is capable of extending outward from the housing via the opening; the first elastic member is disposed between the winding portion and the housing; the first limiting member is disposed at one end of the baffle portion away from the winding portion; wherein the first limiting member and the rotating member are different parts of the same structural member; or the first limiting member and the rotating member are different structural members.

In an optional implementation, the mating structure includes a first mating portion and a third mating portion, the third mating portion is configured to cooperate with the second protrusion to lock the length of pulled out cable, and the first mating portion is configured to rotate the rotating member to retract the pulled out cable, , wherein at least two third mating portions are continuously provided.

In an optional implementation, at least two third mating portions are continuously provided, and at least one first mating portion is provided; wherein a number of third mating portions is greater than a number of first mating portions, and the second protrusion cooperates with the third mating portion at least twice between two retractions of the cable.

In an optional implementation, the mating structure further includes a second mating portion located in a circumferentially of the third limiting member, and the second mating portion is located between the first mating portion and the third mating portion, the third protrusion is configured to cooperate with the third mating portion and the second mating portion to drive the second limiting member to rotate, the second protrusion is configured to cooperate with the third mating portion to position and lock the rotating member, or the second protrusion is configured to cooperate with the first mating portion to make the rotating member continuously rotate.

In an optional implementation, the third mating portion is a third groove defined on the third limiting member, and the first mating portion is a second groove defined on the third limiting member; wherein a distance between a bottom surface of the third groove and a center of the third limiting member is greater than a distance between a bottom surface of the second groove and a center of the third limiting member.

In an optional implementation, the third groove includes a first plane and a second plane, a length of the first plane is greater than a length of the second plane; wherein the third protrusion at least abuts against the first plane to drive the third limiting member to rotate; and the second protrusion at least abuts against the first plane to limit a position of the second limiting member.

In an optional implementation, a contour shape of at least a portion of the second protrusion for insertion into the second groove is adapted to a contour shape of the second groove.

In an optional implementation, multiple first grooves are uniformly arranged.

In an optional implementation, the first protrusion includes a transmission inclined surface and a limiting plane, the transmission inclined surface being inclined toward a direction of rotation when the first limiting member is pulled out.

The data cable device of the present disclosure, through the combined action of the elastic assembly and the mating structure, may be more reliably and stably positioned, thereby enabling the cable to be in a more reliable and stable position at the suitable length for use.

### BRIEF DESCRIPTION OF THE DRAWINGS

To more clearly illustrate the technical solutions in the embodiments of the present disclosure, the accompanying drawings used in the description of the embodiments will be briefly introduced below. Obviously, the accompanying drawings described below are only some embodiments of the present disclosure, for those skilled in the art, other drawings may be obtained based on these drawings without creative effort.

FIG. 1 is a cross-sectional view of a data cable device provided in an embodiment of the present disclosure.

FIG. 2 is a partial schematic diagram of the data cable device provided in an embodiment of the present disclosure, wherein the data cable device is in a positioned state.

FIG. 3 is a partial schematic diagram of the data cable device provided in an embodiment of the present disclosure, wherein the data cable device is in a retracted state.

FIG. 4 is a partial schematic diagram of the data cable device provided in an embodiment of the present disclosure, wherein the data cable device is in a stretched state.

FIG. 5 is a partial schematic diagram of the data cable device shown in FIG. 1.

FIG. 6 is another partial schematic diagram of the data cable device shown in FIG. 1.

FIG. 7 is a schematic diagram of a first half-housing of the data cable device provided in an embodiment of the present disclosure.

FIG. 8 is a structural schematic diagram of a second half-housing of the data cable device provided in an embodiment of the present disclosure.

FIG. 9 is a schematic diagram of the data cable device provided in another embodiment of the present disclosure.

FIG. 10 is a schematic diagram of the data cable device provided in another embodiment of the present disclosure.

FIG. 11 is a schematic diagram of a second limiting member in FIG. 1.

FIG. 12 is a schematic diagram of a third limiting member in FIG. 1.

FIG. 13 is another partial schematic diagram of the data cable device shown in FIG. 1.

FIG. 14 is a schematic diagram of a rotating member of the data cable device provided in the embodiment of the present disclosure.

FIG. 15 is another overall structural schematic diagram of the data cable device shown in FIG. 1.

FIG. 16 is another schematic diagram of a limiting assembly provided in the embodiment of the present disclosure in the positioned state.

FIG. 17 is a schematic diagram of the limiting assembly provided in the embodiment of the present disclosure in the retracted state.

FIG. 18 is a schematic diagram of a second limiting member provided in the embodiment of the present disclosure.

FIG. 19 is another schematic diagram of the limiting assembly installed on the housing.

FIG. 20 is a schematic diagram of a third limiting member provided in the embodiment of the present disclosure.

FIG. 21 is a schematic diagram of a third protrusion cooperating with the third limiting member provided in the embodiment of the present disclosure.

### DETAILED DESCRIPTION

The present disclosure will now be described in further detail with reference to the accompanying drawings and embodiments. The following embodiments are for illustrative purposes only and do not limit the scope of the present disclosure.

In the embodiments described in the present disclosure, unless otherwise stated and limited, the term “connection” should be interpreted broadly. For example, it may refer to an electrical connection, or the internal connection between two components; it may be a direct connection or an indirect connection through an intermediate medium, those skilled in the art may understand the specific meaning of the above terms according to the specific circumstances. It should also be noted that the terms “first”, “second” and “third” involved in the embodiments of the present disclosure are merely used to distinguish similar objects and do not represent a specific order of objects. It is understood that “first”, “second” and “third” may be interchanged in a specific order or sequence where permissible.

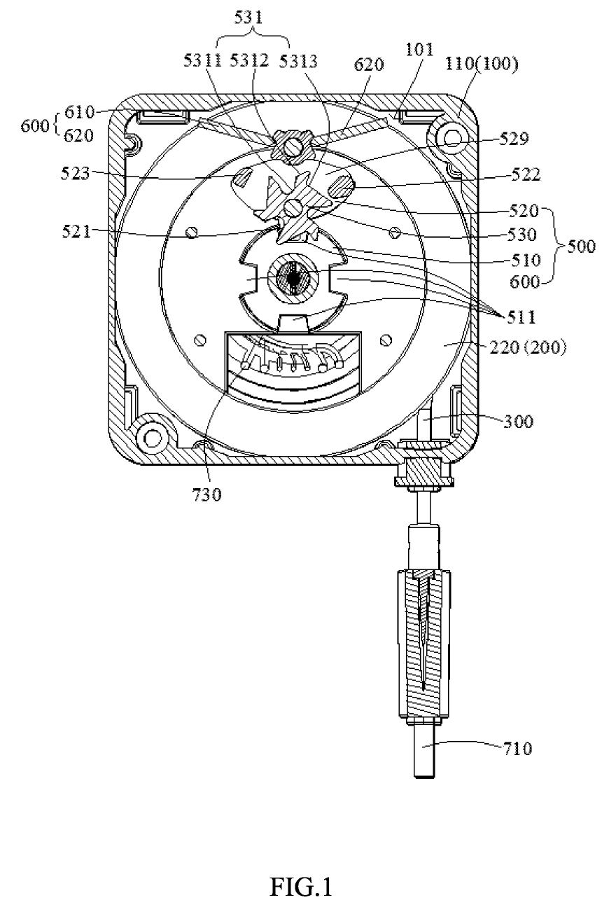

The data cable device described in the embodiments of the present disclosure will be described in detail below with reference to FIGS. 1 to FIG. 21.

The data cable device of the present disclosure may be used to store cables, and the data cable device of the present disclosure may be referred to as a data line storage device. The data cable device of the present disclosure may wind up a cable 300 via a rotating member 200, and the data cable device of the present disclosure may also be referred to as a cable winder.

In some embodiments of the present disclosure, the data cable device includes: a housing 100, a rotating member 200, a cable 300, a first elastic member 400, and a limiting assembly 500. The housing 100 has an accommodating space 101 and an opening 102 in communication with the accommodating space 101; the rotating member 200 is rotatably disposed within the accommodating space 101; a portion of the cable 300 may be coiled on the rotating member 200 and is capable of extending outward from the housing 100 via the opening 102; the first elastic member 400 is disposed between the rotating member 200 and the housing 100 and is used to provide a force to the rotating member 200 to rotate in a retraction direction A; the limiting assembly 500 includes a first limiting member 510, a second limiting member 520, and a third limiting member 530. The first limiting member 510 is disposed at one end of the rotating member 200; the peripheral side of the first limiting member 510 defines at least one first groove 511; a second limiting member 520 is rotatably disposed on the housing 100; the peripheral side of the second limiting member 520 has a first protrusion 521 for engaging with the first groove 511; the end surface 529 of the second limiting member also has a second protrusion 522 and a third protrusion 523 spaced apart; a third limiting member 530 is rotatably disposed on the housing 100 and the third limiting member 530 is located between the second protrusion 522 and the third protrusion 523; the periphery of the third limiting member 530 has at least one set of mating structures 531 for engaging with the second protrusion 522 and the third protrusion 523; the second limiting member 520 is used to push the third limiting member 530 to rotate through the mating structure 531; the elastic assembly 600 is disposed between the second limiting member 520 and the housing 100; the elastic assembly 600 is used to provide a force to the second limiting member 520 to position the first protrusion 521 within the first groove 511, so as to engage with the mating structure 531 to position the second limiting member 520 in the positioned state where the first protrusion 521 is located within the first groove 511.

In the data cable device of the present disclosure, since a portion of the cable 300 may be coiled outside the rotating member 200 and is capable of extending outward from the housing 100 via the opening 102, when the cable 300 is pulled, an external force overcomes the deformation force of the first elastic member 400 and drives the rotating member 200 to rotate through the cable 300, thus increasing the length of the cable 300 extending outside the housing 100. Meanwhile, the first protrusion 521 is located outside the first groove 511, and the elastic member 600 deforms. When the length of the cable 300 extending outside the housing 100 meets the requirements, the cable 300 is no longer pulled, and the first elastic member 400 can provide a force to the rotating member 200 to rotate in the retraction direction, after the rotating member 200 drives the cable 300 to rotate a small distance in the retraction direction, the deformation force of the elastic assembly 600 may cause the second limiting member 520 to rotate until the first protrusion 521 is located in the first groove 511. The mating structure 531 may cooperate with the second protrusion 522 to make the second limiting member 520 be in the positioned state where the first protrusion 521 is located in the first groove 511, thereby preventing the rotating member 200 from driving the cable 300 to continue to rotate in the retraction direction through the first protrusion 521.

In related technologies, a data cable device includes a housing, a rotating structure, and a cable. The cable may be stored inside the housing or extended outside the housing via the rotating structure. When the cable in the data line storage structure is at a suitable length, a set of structures prevents the rotating structure from rotating in the cable retraction direction, resulting in poor stability of the cable at the suitable length. If this structure fails due to manufacturing errors or wear and tear, it will no longer be able to prevent the rotating structure from rotating in the cable-retracting direction, and the cable in the data cable storage structure will not be stably maintained at the suitable length. The data cable device of the present disclosure, through the combined action of the elastic assembly 600 and the mating structure 531, may reliably and stably position the data cable device in a positioned state, thereby ensuring that the cable 300 is reliably and stably maintained at the suitable length.

In some embodiments of the present disclosure, in a stretched state, the elastic assembly 600 is used to provide a force to the second limiting member 520 to rotate along a first direction B, so that the first protrusion 521 is located in the first groove 511, and the mating structure 531 is used to position the second limiting member 520 in a positioned state where the first protrusion 521 is located in the first groove 511 by mating with the second protrusion 522.

Since a portion of the cable 300 may be coiled outside the rotating member 200 and is capable of extending outward from the housing 100 via the opening 102, when the cable 300 is pulled, the external force overcomes the deformation force of the first elastic member 400 and drives the rotating member 200 to rotate through the cable 300, increasing the length of the cable 300 extending outside the housing 100. Meanwhile, the first protrusion 521 is located outside the first groove 511, and the elastic member 600 deforms. When the length of the cable 300 extending outside the housing 100 meets the requirements, the cable 300 is no longer pulled, and the first elastic member 400 may provide a force to the rotating member 200 to rotate in the retraction direction A, after the cable 300 is rotated a short distance in the retraction direction A, the deformation force of the elastic assembly 600 may provide a force to the second limiting member 520 to rotate in the first direction B, so that the second limiting member 520 rotates until the first protrusion 521 is located in the first groove 511, meanwhile, the mating structure 531 may also cooperate with the second protrusion 522 to make the second limiting member 520 be in the positioned state where the first protrusion 521 is located in the first groove 511, thereby preventing the rotating member 200 from driving the cable 300 to continue to rotate in the retraction direction A through the first protrusion 521, so that the cable 300 may be stably in the suitable length for use.

The deformation force of the elastic assembly 600 may also prevent the first protrusion 521 from coming out of the first groove 511, based on this design, through the combined action of the elastic assembly 600 and the mating structure 531, the second limiting member 520 may remain in a more stable positioned state, meanwhile, since the first protrusion 521 is located in the first groove 511, the first protrusion 521 may prevent the rotating member 200 from driving the cable 300 to continue rotating in the retraction direction, so that the cable 300 may be more stably positioned at the suitable length.

In some embodiments, the second protrusion 522 and the third protrusion 523 may have the same or similar axial height, since the second protrusion 522 and the third protrusion 523 on the second limiting member 520 that cooperates with the third limiting member 530 have the same or similar axial height, the second limiting member 520 may be made thinner, so that the data line storage device may also be made thinner, thereby achieving the thinning of the data line storage device.

In embodiments of the present disclosure, the data cable device includes a housing 100, a rotating member 200, a cable 300, a first elastic member 400, and a limiting assembly 500. The housing 100 defines an accommodating space 101 and an opening 102 communicating with the accommodating space 101; the rotating member 200 is rotatably disposed within the accommodating space 101; a portion of the cable 300 may be coiled outside the rotating member 200 and is capable of extending outward from the housing 100 via the opening 102; the first elastic member 400 is disposed between the rotating member 200 and the housing 100 and is used to provide a force to the rotating member 200 to rotate in the retraction direction A; the limiting assembly 500 includes a first limiting member 510, a second limiting member 520, and a third limiting member 530. The first limiting member 510 is disposed at one end of the rotating member 200; the peripheral side of the first limiting member 510 has at least one first groove 511; a second limiting member 520 is rotatably disposed on the housing 100; the peripheral side of the second limiting member 520 has a first protrusion 521 for engaging with the first groove 511; the end surface 529 of the second limiting member also has a second protrusion 522 and a third protrusion 523 spaced apart; the third limiting member 530 is rotatably disposed on the housing 100 and the third limiting member 530 is located between the second protrusion 522 and the third protrusion 523;. the periphery of the third limiting member 530 has at least one set of mating structures 531 for engaging with the second protrusion 522 and the third protrusion 523; the second limiting member 520 is used to push the third limiting member 530 to rotate through the mating structure 531; the elastic assembly 600 is disposed between the second limiting member 520 and the housing 100; the elastic assembly 600 is used to provide a force to the second limiting member 520 to position the first protrusion 521 within the first groove 511, so as to engage with the mating structure 531 to position the second limiting member 520 in the positioned state where the first protrusion 521 is located within the first groove 511positioned state.

In data cable device, since a portion of the cable 300 may be coiled outside the rotating member 200 and is capable of extending outward from the housing 100 via the opening 102, when the cable 300 is pulled, the external force overcomes the deformation force of the first elastic member 400 and drives the rotating member 200 to rotate through the cable 300, increasing the length of the cable 300 extending outside the housing 100, meanwhile, the first protrusion 521 is located outside the first groove 511, and the elastic assembly 600 deforms. When the length of the cable 300 extending outside the housing 100 meets the requirements, the cable 300 is no longer pulled, and the first elastic member 400 may provide a force to the rotating member 200 to rotate in the retraction direction, after the rotating member 200 drives the cable 300 to rotate a small distance in the retraction direction, the deformation force of the elastic assembly 600 may cause the second limiting member 520 to rotate until the first protrusion 521 is located inside the first groove 511; the mating structure 531 may engage with the second protrusion 522 to make the second limiting member 520 be in the positioned state where the first protrusion 521 is located in the first groove 511, meanwhile the deformation force of the elastic assembly 600 may prevent the first protrusion 521 from coming out of the first groove 511. Based on this design, through the combined action of the elastic assembly 600 and the mating structure 531, the second limiting member 520 may remain in a more stable positioned state, meanwhile, since the first protrusion 521 is located in the first groove 511, the first protrusion 521 may prevent the rotating member 200 from driving the cable 300 to continue rotating in the retraction direction, so that the cable 300 may be more stably positioned at the suitable length.

In related technologies, a data cable device includes a housing, a rotating structure, and a cable. The cable may be stored inside the housing or extended outside the housing via the rotating structure. When the cable in the data line storage structure is at a suitable length, a set of structures prevents the rotating structure from rotating in the cable retraction direction, resulting in poor stability of the cable at the suitable length. If this structure fails, due to manufacturing errors or wear and tear, for example, it will no longer be able to prevent the rotating structure from rotating in the cable retracting direction, and the cable in the data cable storage structure will not be stably maintained at the suitable length. The data cable device of the present disclosure, through the combined action of the elastic assembly 600 and the mating structure 531, may reliably and stably position the data cable device in a positioned state, thereby ensuring that the cable 300 is reliably and stably maintained at the suitable length.

The present disclosure does not limit the structure of the housing 100. For example, the housing 100 may be a disc-shaped structure, in another example, the housing 100 may be a cuboid-shaped structure. As an example, as shown in FIG. 9, the housing 100 includes a first half-housing 110 and a second half-housing 120, the first half-housing 110 and the second half-housing 120 may be connected by a snap-fit structure, a threaded structure, etc., and the accommodating space 101 may be defined between the first half-housing 110 and the second half-housing 120. It can be understood that the housing 100 may have one opening 102 or two openings 102.

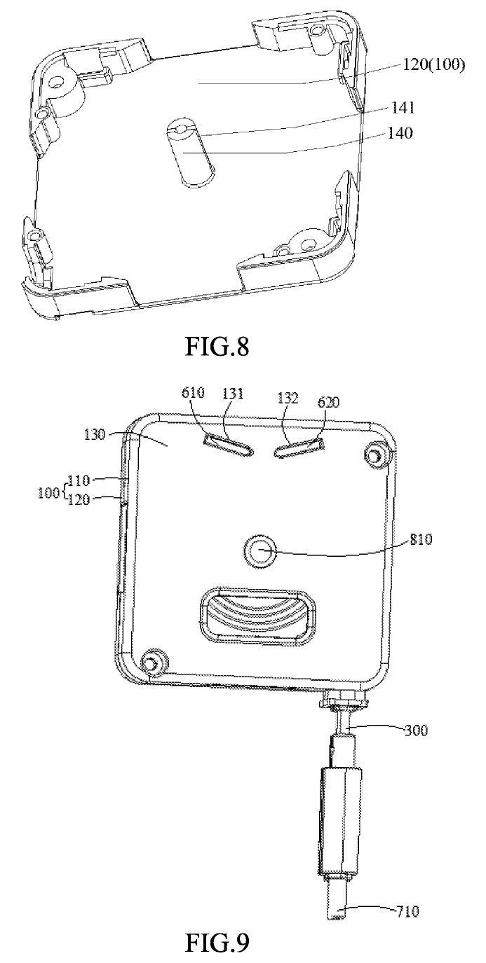

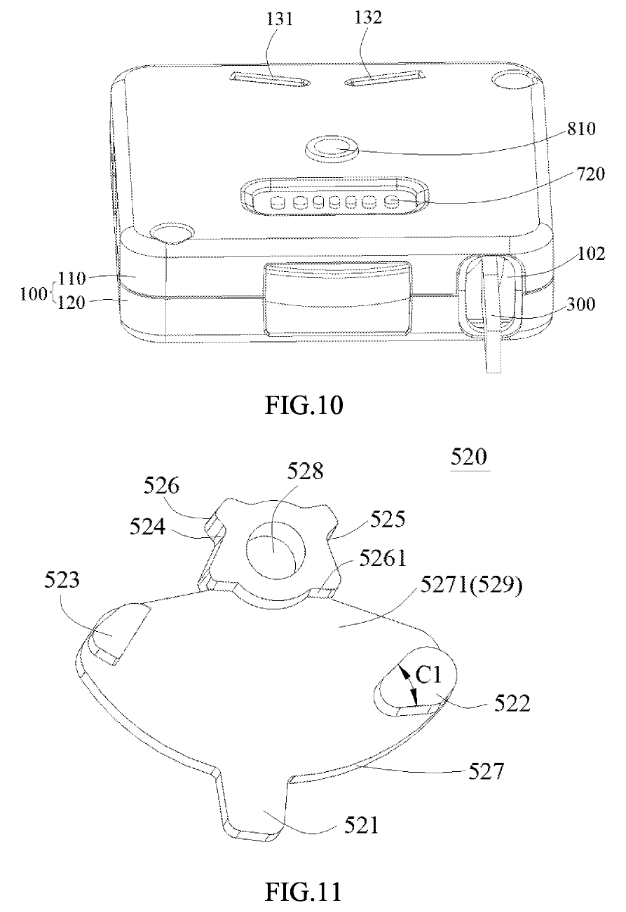

The present disclosure does not limit the structure of the rotating member 200. For example, the rotating member 200 may be a columnar structure. The implementation method in which the rotating member 200 is rotatably disposed within the accommodating space 101 is not limited. For example, the rotating member 200 may be rotatably disposed within the accommodating space 101 via a rotating shaft structure. As an example, a first connecting column 140 is provided within the accommodating space 101, and the rotating member 200 defines a fourth connecting hole 230, the first connecting column 140 passes through the fourth connecting hole 230 and is rotatable within the fourth connecting hole 230; thus, the rotating member 200 may be rotatably disposed within the accommodating space 101 by the first connecting column 140 passing through the fourth connecting hole 230. As shown in FIG. 8, the first connecting column 140 may be fixed to the second half-housing 120. Alternatively, the first connecting column 140 and the second half-housing 120 may be a single structural member. The first connecting column 140 may also be connected to the first half-housing 110. For example, as shown in FIG. 7, the first half-housing 110 defines a first connecting hole 133. As shown in FIGS. 9 and 10, a connector 810 passes through the first connecting hole 133 and connects to the first connecting column 140. The connector 810 may be a screw, and the first connecting column 140 may define a threaded hole. In one application, the first connecting column 140 and the second half-housing 120 are a single structural member.

In the embodiment, the length of the cable 300 may be increased by stretching one end or by stretching both ends. As an example, as shown in FIG. 10, the housing 100 defines an opening 102. As shown in FIG. 1, the first end of the cable 300 may be provided with a first interface 710, and the type of the first interface 710 may be a USB interface or a Type-C interface. The first interface 710 is located outside the housing 100 for interface plugging with an external electronic device. The second end of the cable 300 is located in the accommodating space 101, and the second end of the cable 300 is electrically connected to a second interface 720 provided on the surface of the housing 100 through a connecting wire 730. In some embodiments, a circuit board may also be provided between the second interface 720 and the connecting wire 730 to ensure that the second interface 720 and the cable 300 remain electrically connected during the rotation of the cable 300 relative to the housing 100. In other embodiments, the housing 100 may also define two openings 102, and the two ends of the cable 300 may extend out of the housing 100 from the two openings 102 respectively, so that the length of the cable 300 may be adjusted by stretching the two ends of the cable 300.

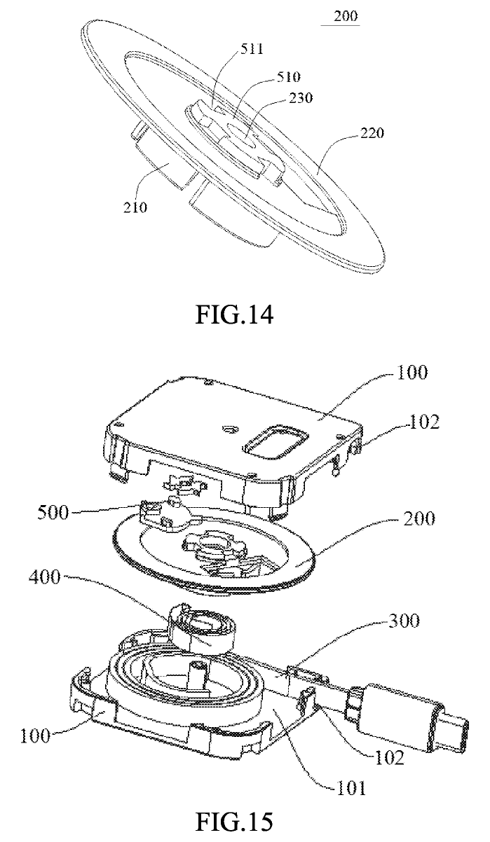

The present disclosure does not limit the structure of the first elastic member 400. The first elastic member 400 may provide a force to the rotating member 200 to rotate in the retraction direction A. For example, as shown in FIG. 13, the first elastic member 400 may be a torsion spring. A first end of the first elastic member 400 is connected to the housing 100, and a second end of the first elastic member 400 is connected to the rotating member 200. When the cable 300 is stretched, the cable 300 drives the rotating member 200 to rotate, and the first elastic member 400 deforms. The first elastic member 400 may provide a force to the rotating member 200 to rotate in the retraction direction A through the restoring force of the deformation. As an example, as shown in FIG. 8, the first connecting column 140 defines a first clamping groove 141, and the first end of the first elastic member 400 is engaged in the first clamping groove 141 to fix the first end of the first elastic member 400 to the housing 100. As another example, as shown in FIG. 14, the rotating member 200 has a winding portion 210 and a baffle portion 220 in an axial direction, the winding portion 210 is adjacent to the baffle portion 220, and a first elastic member 400 is disposed between the winding portion 210 and the housing 100. As shown in FIG. 13, the winding portion 210 may be a ring-shaped structure, and a portion of the first elastic member 400 is wound around a cavity of the winding portion 210. The wall of the winding portion 210 defines a second clamping groove 211, and the second end of the first elastic member 400 is engaged in the second clamping groove 211 to fix the second end of the first elastic member 400 to the winding portion 210 of the rotating member 200. It can be understood that a portion of the cable 300 may be coiled outside the winding portion 210 and is capable of extending outward from the housing 100 via the opening 102.

In the embodiment, the limiting assembly 500 includes a first limiting member 510, a second limiting member 520, a third limiting member 530, and an elastic assembly 600. The cooperation of the first limiting member 510, the second limiting member 520, the third limiting member 530, and the elastic assembly 600 enables the rotating member 200 to be positioned relative to the housing 100, thereby ensuring that the cable 300 is stably at a suitable length for use.

The present disclosure does not limit the structure of the first limiting member 510. For example, the first limiting member 510 may be a plate-shaped structure. As an example, as shown in FIG. 1, the first limiting member 510 may be a disc-shaped structure. When the rotating member 200 includes a winding portion 210 and a baffle portion 220, the first limiting member 510 may be disposed at the end of the baffle portion 220 opposite to the winding portion 210, thereby separating the winding portion 210 and the first limiting member 510 through the baffle portion 220, that is, the cable 300 is separated from the limiting assembly 500 to prevent the cable 300 and the limiting assembly 500 from interfering with each other. As shown in FIG. 14, the first limiting member 510 and the rotating member 200 may be different parts of the same structural member, so as to facilitate manufacturing and improve the connection strength between the first limiting member 510 and the baffle portion 220. The first limiting member 510 and the rotating member 200 may also be different structural members, and the first limiting member 510 and the rotating member 200 may be connected by bonding, welding, threaded structure, etc.

The number of first grooves 511 on the periphery of the first limiting member 510 is not limited. As an example, as shown in FIGS. 1 to 4, four first grooves 511 are uniformly provided on the periphery of the first limiting member 510 in the circumferential direction.

The second limiting member 520 may be rotatably mounted on the housing 100 via a rotating shaft structure. For example, as shown in FIG. 7, the first half-shell 110 has a third connecting column 135, and as shown in FIG. 11, the second limiting member 520 defines a third connecting hole 528. The third connecting column 135 is inserted into the third connecting hole 528 and may rotate within the third connecting hole 528, thereby enabling the second limiting member 520 to be rotatably mounted on the housing 100 by inserting the third connecting column 135 into the third connecting hole 528. In other embodiments, the third connecting column 135 may also be mounted on the second limiting member 520, and the third connecting hole 528 may also be mounted on the housing 100.

In the embodiment of FIGS. 7 and 11, the second limiting member 520 has a first protrusion 521 on its periphery for engaging with the first groove 511. When the rotating member 200 rotates to a position where the first groove 511 faces the second limiting member 520, the second limiting member 520 may rotate until the first protrusion 521 is located within the first groove 511, so that the second limiting member 520 and the rotating member 200 are engaged and connected, thus, by having the first protrusion 521 located within the first groove 511, the second limiting member 520 may prevent the rotating member 200 from rotating, or by having the first protrusion 521 located within the first groove 511, the rotating member 200 may drive the second limiting member 520 to rotate. It is understood that the second limiting member 520 may also rotate until the first protrusion 521 is located outside the first groove 511, so that the second limiting member 520 and the rotating member 200 are separated.

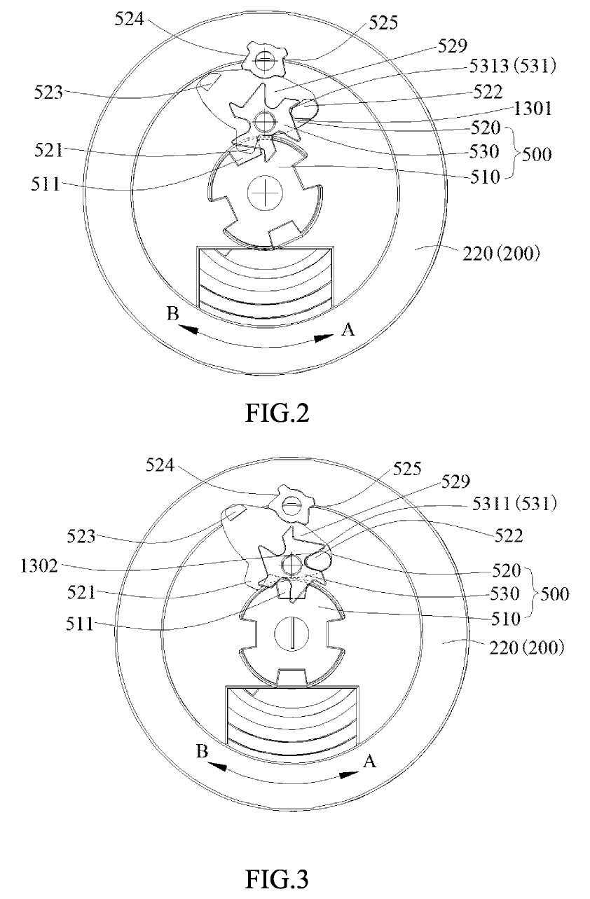

As shown in FIGS. 1 and 2, the end surface 529 of the second limiting member also has a second protrusion 522 and a third protrusion 523 spaced apart; the axial heights of the second protrusion 522 and the third protrusion 523 may be the same or similar. It is understood that the axial heights of the second protrusion 522 and the third protrusion 523 may also be different. The end surface 529 of the second limiting member refers to the surface perpendicular to the axis of the second limiting member 520. The cross-sectional shapes of the second protrusion 522 and the third protrusion 523 are not limited. For example, the cross-section of the second protrusion 522 may be elliptical, and the cross-section of the third protrusion 523 may be similar to a triangle.

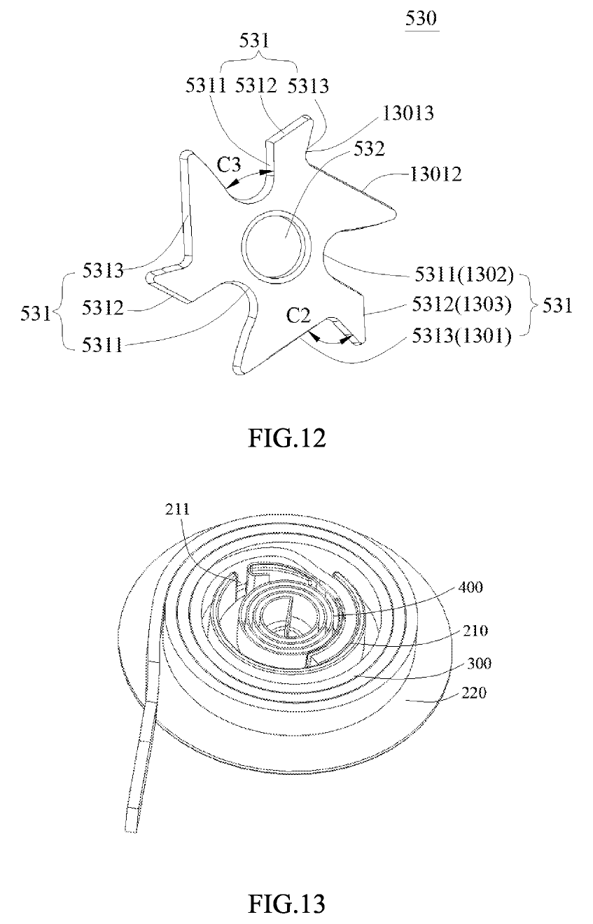

The third limiting member 530 may be rotatably mounted on the housing 100 via a rotating shaft structure. For example, as shown in FIG. 7, the first half-housing 110 has a second connecting column 134, and as shown in FIG. 12, the third limiting member 530 defines a second connecting hole 532. The second connecting column 134 is inserted into the second connecting hole 532 and may rotate within the second connecting hole 532, thereby enabling the third limiting member 530 to be rotatably mounted on the housing 100 by inserting the second connecting column 134 into the second connecting hole 532. In other embodiments, the second connecting column 134 may also be mounted on the third limiting member 530, and the second connecting hole 532 may also be mounted on the housing 100.

The axis of the third limiting member 530 and the axis of the second limiting member 520 may be parallel, so that the second limiting member 520 may smoothly rotate the third limiting member 530 by means of the mating structure 531. It is understood that the end surface of the third limiting member 530 and the end surface 529 of the second limiting member may be arranged adjacent to each other. In this embodiment, there are no other structural members between the end surface of the third limiting member 530 and the end surface 529 of the second limiting member, and a gap between the end surface of the third limiting member 530 and the end surface 529 of the second limiting member may be set to be small, thereby reducing the installation space of the limiting assembly 500. As an example, the third limiting member 530 and the second protrusion 522 are at the same or similar height in the axial direction. That is, the third limiting member 530 may be arranged within the space defined by the second protrusion 522 and the third protrusion 523. In this embodiment, it is not necessary to provide separate installation space for the third limiting member 530 in the housing 100, thereby achieving a thinner and lighter data cable storage device. It is understood that the end surface of the third limiting member 530 refers to the surface of the third limiting member 530 that is perpendicular to the axis of the third limiting member 530.

The third limiting member 530 is located between the second protrusion 522 and the third protrusion 523; the periphery of the third limiting member 530 has at least one set of mating structures 531 for cooperating with the second protrusion 522 and the third protrusion 523; the second limiting member 520 is used to push the third limiting member 530 to rotate through the mating structures 531 so that different areas of the mating structures 531 cooperate with the second protrusion 522 and the third protrusion 523, thereby putting the data line storage device in different states.

The form of the mating structure 531 is not limited. The mating structure 531 may engage with the second protrusion 522 to position the second limiting member 520 within the first groove 511 where the first protrusion 521 is located. As an example, the axial thickness of the third limiting member 530 is uniformly set, and the mating structure 531 is set along the circumference of the third limiting member 530, since the mating structure 531 is set along the circumference of the third limiting member 530, the axial thickness of the third limiting member 530 may be set more uniformly, thereby achieving a thinner axial profile for the third limiting member 530. In other examples, the axial thickness of the third limiting member 530 may also be non-uniformly set. In this embodiment, a portion of the mating structure 531 may be set along the circumference of the third limiting member 530, and the remaining portion of the mating structure 531 may be set along the axial direction of the third limiting member 530.

The number of mating structures 531 is not limited. For example, as shown in FIG. 12, the third limiting member 530 has three sets of mating structures 531, which are evenly distributed along the circumference of the third limiting member 530.

In the embodiment, the structure of the elastic assembly 600 is not limited. The elastic assembly 600 may be used to provide a bidirectional rotational force to the second limiting member 520, or the elastic assembly 600 may be used to provide a unidirectional rotational force to the second limiting member 520. For example, in the stretched state, the elastic assembly 600 is used to provide a force to rotate the second limiting member 520 along the first direction B, so that the first protrusion 521 is located in the first groove 511.

As an example, the structure of the elastic assembly 600 is not limited. In the stretched state, the elastic assembly 600 provides a force to the second limiting member 520 to rotate along the first direction B, so that the first protrusion 521 is located within the first groove 511. For example, the elastic assembly 600 may include a spring sheet, the first end of the spring sheet may be fixed to the housing 100, and the second end of the spring sheet may contact the second limiting member 520. In the stretched state, the spring sheet is in a deformed state, and the spring sheet provides a force to the second limiting member 520 to rotate along the first direction B through the deformation force, so that the first protrusion 521 is located within the first groove 511.

The structure of the elastic assembly 600 is not limited. The elastic assembly 600 is used to provide a force to the second limiting member 520 to rotate bidirectionally to cause the first protrusion 521 to be disposed within the first groove 511, so as to engage with the mating structure 531 to position the second limiting member 520 in the positioned state where the first protrusion 521 is located within the first groove 511. In the stretched state, the elastic assembly 600 is used to provide a force to the second limiting member 520 to rotate along the first direction B so that the first protrusion 521 is disposed within the first groove 511; in the positioned state, the elastic assembly 600 is used to provide a force to the second limiting member 520 to rotate along the second direction A, to prevent the first protrusion 521 from dislodging from the first groove 511, thereby ensuring that the data cable device is stably positioned.

For example, the elastic assembly 600 may include two spring sheets, the first ends of the two spring sheets may be fixed to the housing 100, and the second ends of the two spring sheets may contact the two opposite sides of the second limiting member 520. In the stretched state, one spring sheet is in a deformed state and is used to provide a force to the second limiting member 520 to rotate in the first direction B through the deformation force, so that the first protrusion 521 is located in the first groove 511. In the positioned state, another spring sheet is in a deformed state and is used to provide a force to the second limiting member 520 to rotate in the second direction A through the deformation force, so as to prevent the first protrusion 521 from coming out of the first groove 511.

In another example, the elastic assembly 600 may include a torsion spring, and the torsion spring may be sleeved on a rotating shaft structure between the second limiting member 520 and the housing 100. When the first protrusion 521 is facing the first limiting member, the torsion spring is in its natural state, and the torsion spring is not deformed. In the stretched state, the first protrusion 521 deflects, and the torsion spring deforms. The torsion spring is used to provide a force to the second limiting member 520 to rotate in the first direction B, so that the first protrusion 521 is located in the first groove 511. In the positioned state, the first protrusion 521 deflects, and the torsion spring deforms. The torsion spring is used to provide a force to the second limiting member 520 to rotate in the second direction A, so as to prevent the first protrusion 521 from coming out of the first groove 511, thereby making the data cable device stably positioned.

In some embodiments of the present disclosure, the mating structure 531 may include a first mating portion 1302, a second mating portion 1303, and a third mating portion 1301 arranged adjacent to each other along the circumference of the third limiting member 530. The first mating portion 1302 and the third mating portion 1301 are used to cooperate with the second protrusion 522. The second mating portion 1303 is used to cooperate with the third protrusion 523. A distance between the first mating portion 1302 and the axis is smaller than a distance between the third mating portion 1301 and the axis. In the stretched state, the second mating portion 1303 cooperates with the third protrusion 523, and in the positioned state, the second protrusion 522 is in contact with the third mating portion 1301retracted state, in the retracted state, the second protrusion 522 cooperates with the first mating portion 1302 so that when the data line storage device switches between two adjacent states, the second limiting member 520 may push the third limiting member 530 to rotate through the mating structure 531, so that when entering the next state, the second limiting member 520 and the third limiting member 530 engage at different positions, thereby allowing the second limiting member 520 to present different states.

The structures of the first mating portion 1302, the second mating portion 1303, and the third mating portion 1301 are not limited.

For example, as shown in FIGS. 1 to 4, the first mating portion 1302 includes a second groove 5311, the second mating portion 1303 includes a first side surface 5312, and the third mating portion 1301 includes a third groove 5313; the second groove 5311 and the third groove 5313 are used to cooperate with the second protrusion 522; the first side surface 5312 is used to cooperate with the second side surface of the third protrusion 523. The depth of the second groove 5311 is greater than the depth of the third groove 5313, and a distance between the second groove 5311 and the axis is less than a distance between the third groove 5313 and the axis. In the stretched state, the first side surface 5312 and the second side surface are arranged adjacent to each other. In the positioned state, the second protrusion 522 is located in the third groove 5313, and in the stored state, the second protrusion 522 is located in the second groove 5311.

The third protrusion 523 is also used to cooperate with the third groove 5313 (the third mating portion 1301) to push the third limiting member 530 to rotate.

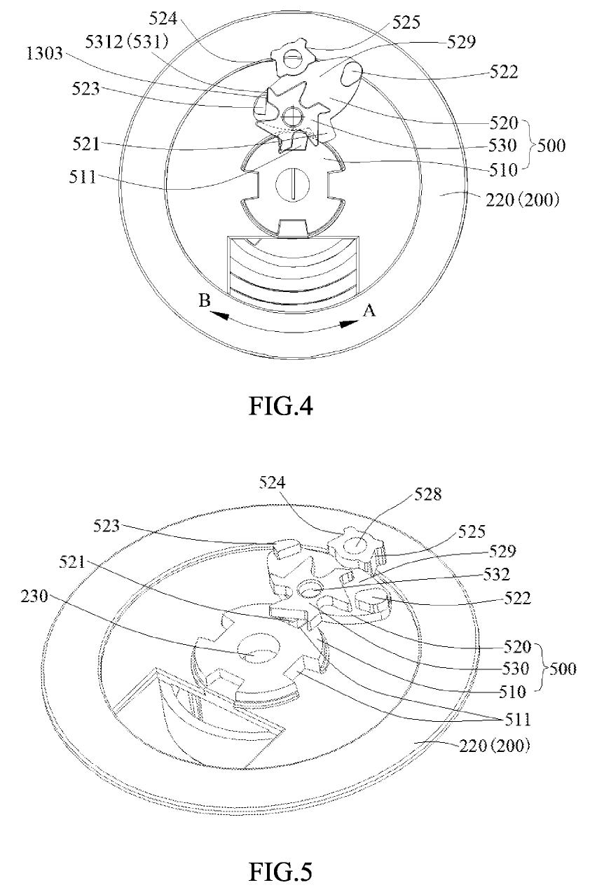

During use, as shown in FIG. 4, in the stretched state, an external force overcomes the deformation force of the first elastic member 400 to pull the cable 300, and the cable 300 drives the rotating member 200 to rotate along the direction B, and the length of the cable 300 increases, meanwhile, the first protrusion 521 is located outside the first groove 511. When the cable 300 is pulled to a suitable length, the external force is removed, and the rotating member 200 rotates in the retraction direction A under the action of the deformation force of the first elastic member 400. When the rotating member 200 rotates to the side where the first groove 511 faces the second limiting member 520, the elastic assembly 600 provides a force to the second limiting member 520 to rotate along the first direction B, causing the first protrusion 521 is located within the first groove 511. Meanwhile, in the stretched state, since the first side surface 5312 and the second side surface are disposed adjacent to each other, the second limiting member 520 also pushes the third limiting member 530 to rotate. When the second limiting member 520 rotates until the second protrusion 522 is located within the third groove 5313, as shown in FIG. 2, the third limiting member 530 prevents the second limiting member 520 from rotating, since the first protrusion 521 is located within the first groove 511. In such a scenario, the resistance of the first protrusion 521 to the rotating member 200 is greater than the force provided by the first elastic member 400 for the rotating member 200 in the retraction direction A, thereby causing the second limiting member 520 to be positioned where the first protrusion 521 is located within the first groove 511, and the cable 300 is secured and stable at the suitable length. When it is necessary to store the cable 300 inside the housing 100, the cable 300 may be pulled again by external force, the cable 300 drives the rotating member 200 to rotate along the direction B, thereby causing the first protrusion 521 to disengage from the first groove 511. In such a scenario, since the third protrusion 523 will push the third limiting member 530 to rotate to the position corresponding to the second protrusion 522 and the second groove 5311 by cooperating with the third groove 5313 (third mating portion 1301), when the external force is removed, the first protrusion 521 will be located back in the first groove 511, and the rotating member 200 will drive the second limiting member 520 to rotate a certain angle along the first direction B through the first protrusion 521. When the second limiting member 520 rotates to the point where the second protrusion 522 is located in the second groove 5311, since the depth of the second groove 5311 is greater than the depth of the third groove 5313, the first protrusion 521 is located outside the first groove 511, as shown in FIG. 3. In such a scenario, the second limiting member 520 cannot prevent the rotating member 200 from rotating through the first protrusion 521, and the rotating member 200 rotates along the retraction direction A under the action of the first elastic member 400 until the part of the cable 300 that may be coiled outside the rotating member 200 is completely coiled outside the rotating member 200. When the length of the cable 300 needs to be adjusted, the cable 300 may be pulled by external force to overcome the deformation force of the first elastic member 400, the cable 300 drives the rotating member 200 to rotate along the direction B. When the rotating member 200 rotates to the point where the first groove 511 faces the second limiting member 520, the first protrusion 521 enters the first groove 511, and the rotating member 200 may drive the second limiting member 520 to rotate along the second direction A through the first protrusion 521, meanwhile, since the second protrusion 522 is located in the second groove 5311, the second limiting member 520 may push the third limiting member 530 to rotate at a certain angle. When the rotating member 200 drives the second limiting member 521 to rotate along the second direction A through the first protrusion 521 until the first protrusion 521 is located outside the first groove 511, the data line storage device is in the stretched state again, as shown in FIG. 4. In such a scenario, the first side surface 5312 and the second side surface are arranged adjacent to each other. The data line storage device may repeat the above process during use, sequentially switching between the stretched state, the positioned state, and the retracted state to facilitate its use. In other forms of use, the data line storage device may also be in the retracted state for a short period, in this embodiment, the user may adjust the length of the cable 300 by repeatedly switching the data line storage device between the stretched state, the positioned state, and the retracted state. Therefore, the data line storage device is in the retracted state to re-enter the stretched state and the state positioned state, not to completely store the cable 300 inside the housing 100.

In this configuration, the second direction A is opposite to the first direction B, the direction B is opposite to the retraction direction A, and the second direction A is the same as the retraction direction A. For example, the direction B is clockwise, the first direction B is clockwise, the retraction direction A is counterclockwise, and the second direction A is counterclockwise.

During use, when the data line storage device switches between adjacent states, the second limiting member 520 may push the third limiting member 530 to rotate by a set angle through the mating structure 531, so that when entering the next state, the second limiting member 520 and the third limiting member 530 match different positions, so that the first protrusion 521 of the second limiting member 520 and the first groove 511 are in different relative positional relationships.

In this example, as shown in FIGS. 1 and 12, the periphery of the third limiting member 530 also has a protrusion structure located between the second groove 5311 and the third groove 5313, and the first side surface 5312 may be located on the side of the protrusion structure facing the second groove 5311.

In this example, as shown in FIG. 3, the shape of the insertion end of the second protrusion 522 matches the shape of the second groove 5311. The end surface of the insertion end of the second protrusion 522 is used to contact the bottom surface of the second groove 5311, so that the insertion end of the second protrusion 522 may be fully inserted into the second groove 5311, thereby ensuring that the data line storage device is stably in a storage state. In other embodiments, the side surface of the insertion end of the second protrusion 522 may be used to contact the side surface of the second groove 5311.

As shown in FIG. 2, the end surface of the insertion end of the second protrusion 522 is used to contact the side surface of the third groove 5313 to stably position the data line storage device. In other embodiments, the end surface of the insertion end of the second protrusion 522 may be used to contact the bottom surface of the second groove 5311. As an example, as shown in FIG. 11, a first included angle C1 between the two side surfaces of the insertion end of the second protrusion 522 is less than 45 degrees, and as shown in FIG. 12, a second included angle C2 between the two side surfaces of the third groove 5313 is greater than 90 degrees, so that the end surface of the insertion end of the second protrusion 522 may contact the side surface of the third groove 5313. The value of the first included angle C1 is not limited, for example, the range of the first included angle C1 may be from 39 degrees to 41 degrees; the value of the second included angle C2 is not limited, for example, the range of the second included angle C2 may be from 100 degrees to 105 degrees. As shown in FIG. 12, the range of the third included angle C3 between the two side surfaces of the second groove 5311 may be 40 degrees to 42 degrees, so that the insertion end of the second protrusion 522 is inserted into the second groove 5311, and the end surface of the insertion end of the second protrusion 522 is used to contact the bottom surface of the second groove 5311.

In other examples, the first mating portion 1302, the second mating portion 1303, and the third mating portion 1301 may also have other structural forms. For example, the first mating portion 1302, the second mating portion 1303, and the third mating portion 1301 may all be groove structures, or, some of the first mating portions 1302, the second mating portions 1303, and the third mating portions 1301 are groove structures, and the remaining parts of the first mating portions 1302, the second mating portions 1303, and the third mating portions 1301 are planar structures. In the stretched state, the second mating portion 1303 engages with the third protrusion 523; in the positioned state, the second protrusion 522 contacts the third mating portion 1301; and in the retracted state, the second protrusion 522 engages with the first mating portion 1302, so that when switching between the two states, the second limiting member 520 may push the third limiting member 530 to rotate.

In some embodiments of the present disclosure, as shown in FIG. 11, the second limiting member 520 may include a first structural portion 526 and a second structural portion 527. The first structural portion 526 is rotatably connected to the housing 100, and an elastic assembly 600 is disposed between the first structural portion 526 and the housing 100 so that the elastic assembly 600 provides a force to rotate the second limiting member 520 along a first direction B through the first structural portion 526. A first side of the second structural portion 527 is connected to the first structural portion 526, and a second side of the second structural portion 527 has a first protrusion 521, and the second protrusion 522 and the third protrusion 523 is located on the end surface 5271 of the second structural portion.

In the embodiment, the end surface 5271 of the second structural portion refers to the surface of the second structural portion 527 that is perpendicular to the axis of the second limiting member 520.

In the embodiment, the way in which the first structural portion 526 is rotatably connected to the housing 100 is similar to the way in which the second limiting member 520 is rotatably connected to the housing 100, and will not be described again here. In an example, as shown in FIG. 11, the third connecting hole 528 is defined in the first structural portion 526. The way in which the elastic assembly 600 is provided between the first structural portion 526 and the housing 100 is similar to the way in which the elastic assembly 600 is provided between the second limiting member 520 and the housing 100, and will not be described again here.

In the embodiment, a first portion 5261 of the first structural portion protrudes axially from the end surface 5271 of the second structural portion, and the third limiting member 530 is located within a space defined by the first portion 5261, the second protrusion 522, and the third protrusion 523 of the first structural portion, and the axial installation space of the third limiting member 530 may be reduced, meanwhile, since the first portion 5261 of the first structural portion protrudes axially from the end surface 5271 of the second structural portion, that is, the first portion 5261, the second protrusion 522, and the third protrusion 523 of the first structural portion are on the same side of the second limiting member 520, the axial dimension of the first structural portion 526 may be increased to improve the fit strength between the first structural portion 526 and the elastic assembly 600, and the overall axial dimension of the second limiting member 520 may be reduced.

In the embodiment, the second protrusion 522 and the first portion 5261 of the first structural portion are at the same or similar height in the axial direction. That is, the first portion 5261 of the first structural portion will not increase the overall size of the second limiting member 520 in the axial direction, thereby making the axial size of the second limiting member 520 as small as possible, so as to achieve the thinning of the data line storage device.

In some embodiments of the present disclosure, the data line storage device may also have a retracted state; in the stretched state, the elastic assembly 600 provides a force to the second limiting member 520 to rotate along the first direction B, and the first protrusion 521 is located outside the first groove 511; in the retracted state, the elastic assembly 600 provides a force to the second limiting member 520 to rotate along the second direction A, and the first protrusion 521 is located outside the first groove 511; in the positioned state, the elastic assembly 600 provides a force to the second limiting member 520 to rotate along the second direction A, the first protrusion 521 is located inside the first groove 511, and the second direction A is opposite to the first direction B.

In the embodiment, as shown in FIG. 2, in the positioned state, the elastic assembly 600 provides a force to the second limiting member 520 to rotate along the second direction A, the deformation force of the elastic assembly 600 prevents the second limiting member 520 from rotating along the first direction B, at this time, both the elastic assembly 600 and the mating structure 531 are used to prevent the second limiting member 520 from rotating along the first direction B, allowing the first protrusion 521 to be more stably positioned within the first groove 511, thus preventing the rotating member 200 from rotating in the retraction direction A. In other embodiments, in the positioned state, the elastic assembly 600 may not provide a force to the second limiting member 520 to rotate along the second direction A. In this embodiment, the mating structure 531 is used to prevent the second limiting member 520 from rotating along the first direction B.

In the embodiment, as shown in FIG. 3, in the retracted state, the elastic assembly 600 provides a force to the second limiting member 520 to rotate along the second direction A, so that when switching from the retracted state to the stretched state, the force provided by the elastic assembly 600 to the second limiting member 520 to rotate along the second direction A allows the first protrusion 521 to quickly enter the first groove 511. In other embodiments, in the retracted state, the elastic assembly 600 may not provide a force to the second limiting member 520 to rotate along the second direction A.

As an example, in the stretched state, the elastic assembly 600 provides a force to the second limiting member 520 to rotate in the first direction B, and the first protrusion 521 is located outside the first groove 511; in the retracted state, the elastic assembly 600 provides a force to the second limiting member 520 to rotate in the second direction A, and the first protrusion 521 is located outside the first groove 511; in the positioned state, the elastic assembly 600 does not provide a force to the second limiting member 520 to rotate in the second direction A, and the first protrusion 521 is located inside the first groove 511.

In the embodiment, the structure of the elastic assembly 600 is not limited. In the stretched state, the elastic assembly 600 provides a force to the second limiting member 520 to rotate in the first direction B. In the retracted state, the elastic assembly 600 provides a force to the second limiting member 520 to rotate in the second direction A. In the positioned state, the elastic assembly 600 can provide a force to the second limiting member 520 to rotate in the second direction A.

For example, the elastic assembly 600 may include a third elastic member 620 and a second elastic member 610. The third elastic member 620 is used to provide a force to the second limiting member 520 to rotate along the first direction B; the second elastic member 610 is used to provide a force to the second limiting member 520 for rotation in a second direction A.

In this example, the structure of the third elastic member 620 and the second elastic member 610 is not limited. For example, both the third elastic member 620 and the second elastic member 610 may be sheet-shaped structures, and the third elastic member 620 and the second elastic member 610 may be located on opposite sides of the second limiting member 520. Alternatively, both the third elastic member 620 and the second elastic member 610 may be torsion spring structures, and the third elastic member 620 and the second elastic member 610 may be disposed on the rotating shaft structure between the second limiting member 520 and the housing 100. As an example, the third elastic member 620 and the second elastic member 610 may be torsion spring structures sleeved on the third connecting column 135.

For example, the second elastic member 610 and the third elastic member 620 are disposed on the housing 100; the second elastic member 610 and the third elastic member 620 are located on opposite sides of the second limiting member 520, and the second elastic member 610 and the third elastic member 620 are used to contact the second limiting member 520.

Both the second elastic member 610 and the third elastic member 620 may be strip-shaped structures, and the second elastic member 610 and the third elastic member 620 may also be sheet-shaped structures.

As shown in FIG. 1, the first end of the second elastic member 610 is connected to the housing 100, the second end of the second elastic member 610 is used to contact the second limiting member 520; the first end of the third elastic member 620 is connected to the housing 100, and the second end of the third elastic member 620 is used to contact the second limiting member 520.

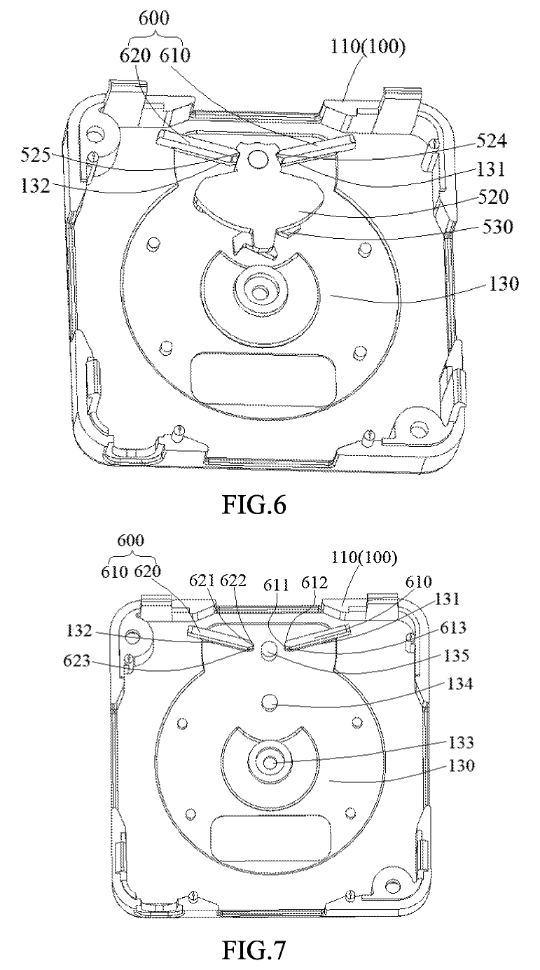

As shown in FIGS. 5 and 6, the second limiting member 520 has a first concave portion 524 and a second concave portion 525 disposed opposite to each other on the periphery of the second limiting member 520, the second end of the second elastic member 610 may be located in the first concave portion 524, and the second end of the third elastic member 620 may be located in the second concave portion 525, so as to ensure that the second end of the second elastic member 610 is always in contact with the second limiting member 520, and the second end of the third elastic member 620 is always in contact with the second limiting member 520, thus preventing the second elastic member 610 and the third elastic member 620 from separating from the second limiting member 520 respectively.

As shown in FIG. 7, the second end of the second elastic member 610 includes a first contact arc surface 611, and a first contact plane 612 and a second contact plane 613 located on both sides of the first contact arc surface 611, so that the second end of the second elastic member 610 may rotate smoothly within the first concave portion 524, thus preventing the second end of the second elastic member 610 from getting stuck and damaged; the second end of the third elastic member 620 includes a second contact arc surface 621, a third contact plane 622 and a fourth contact plane 623 located on both sides of the second contact arc surface 621, so that the second end of the third elastic member 620 may rotate smoothly within the second concave portion 525, thus preventing the second end of the third elastic member 620 from getting stuck and damaged.

In this example, as shown in FIGS. 6 and 7, the housing 100 may include a first wall 130, a second limiting member 520 and a third limiting member 530 disposed on the first wall 130, the second elastic member 610 and the third elastic member 620 are respectively connected to the side of the first wall 130 facing the accommodating space 101. On a projection plane parallel to the rotation axis, the projection areas of the second elastic member 610 and the third elastic member 620 are located outside the projection area of the first wall 130, by disposing the second elastic member 610 and the third elastic member 620 on the side of the first wall 130 facing the accommodating space 101, it may ensure that the first wall 130 does not affect the deformation of the second elastic member 610 and the third elastic member 620, and the placement space of the second elastic member 610 and the third elastic member 620 may be reduced, thereby achieving a thinner and lighter data line storage device.

The first wall 130 may be located in the first half-housing 110, and the first half-housing 110 includes the first wall 130 and sidewalls located around the first wall 130.

As shown in FIG. 10, the first wall 130 may define a first slot 131 and a second slot 132. The first slot 131 communicates with the accommodating space 101 and corresponds to the position of the second elastic member 610, the second slot 132 communicates with the accommodating space 101 and corresponds to the position of the third elastic member 620. On the projection plane perpendicular to the rotation axis, the contour line of the first slot 131 is adjacent to a portion of the contour line of the second elastic member 610, and the contour line of the second slot 132 is adjacent to a portion of the contour line of the third elastic member 620, the first slot 131 and the second slot 132 may increase the deformation space of the second elastic member 610 and the third elastic member 620, and the second elastic member 610 and the third elastic member 620 may also cover the first slot 131 and the second slot 132, thus making the data line storage device more tidy as a whole.

The first wall 130, the second elastic member 610, and the third elastic member 620 may be different parts of the same structural member to facilitate manufacturing, meanwhile, the elastic assembly 600 is formed through partial structures on the housing 100, which may significantly simplify the structure of the data line storage device. As an example, the first wall 130, the second elastic member 610, and the third elastic member 620 may be integrally molded by injection molding. The first wall 130, the second elastic member 610, and the third elastic member 620 may also be different structural components, the second elastic member 610 and the third elastic member 620 may be fixed to the first wall 130 by bonding, welding, threaded connection, or other methods.

When the elastic assembly 600 is only used in the stretched state to provide a force to the second limiting member 520 to rotate along the first direction B, the elastic assembly 600 may only include the third elastic assembly620. In the stretched state, the elastic assembly 600 provides a force to the second limiting member 520 to rotate along the first direction B; in the retracted state, the elastic assembly 600 provides a force to the second limiting member 520 to rotate along the second direction A; and in the positioned state, the elastic assembly 600 does not provide a force to the second limiting member 520 to rotate along the second direction A, the elastic assembly 600 may include the third elastic assembly620 and the second elastic assembly 610, and the second elastic assembly 610 may be shorter. In the positioned state, the second elastic assembly 610 contacts the second limiting member 520, and the second elastic assembly 610 does not deform and does not exert a deformation force. In the retracted state, the second elastic assembly deforms and may provide a deformation force.

In some embodiments, as shown in FIGS. 1 and 15, the accommodating space 101 of the housing 100 may also be referred to as an accommodating cavity, the rotating member 200 is rotatably disposed on the housing 100, and the rotating member 200 may also be referred to as a wheel core. The cable 300 is used for data transmission, and the cable 300 may also be referred to as a wire; the rotational position of the rotating member 200 relative to the housing 100 may be adjusted by the limiting assembly 500, and the limiting assembly 500 may also be referred to as an adjustment assembly.

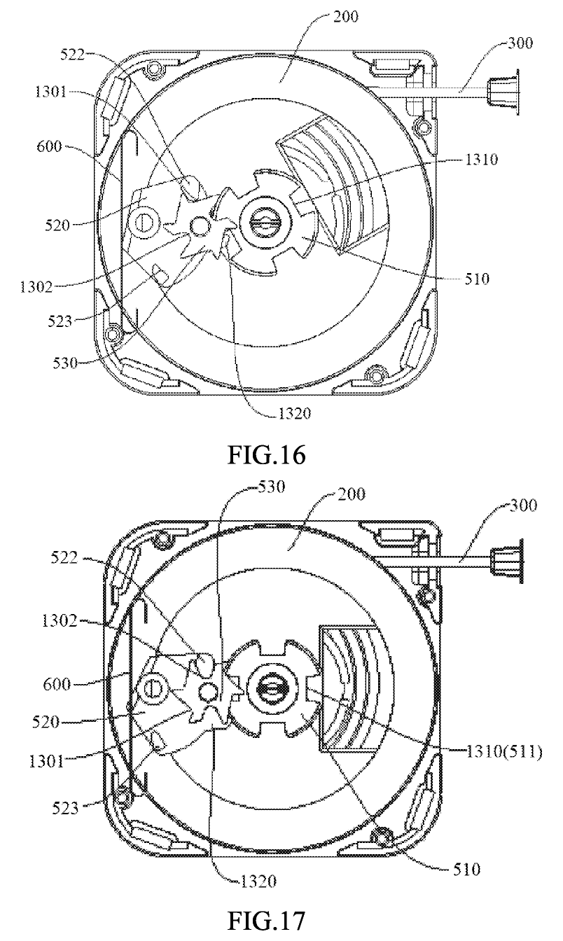

In some embodiments, as shown in FIGS. 1 and 16, a first limiting member 510 is disposed on the rotating member 200, the first limiting member 510 may drive a portion of the limiting assembly 500 to move, and the first limiting member 510 may also be referred to as a drive wheel. The rotation position of the rotating member 200 relative to the housing 100 may be adjusted by the second limiting member 520, the third limiting member 530 and the first limiting member 510. The second limiting member 520 may also be referred to as a second adjusting member, and the third limiting member 530 may also be referred to as a first adjusting member.

In some embodiments, as shown in FIGS. 1 and 17, the first limiting member 510 provides a driving force through the cooperation between the first protrusion 521 of the second limiting member 520 and the first groove 511, the first groove 511 may also be referred to as a transmission groove, and the first protrusion 521 may also be referred to as a transmission protrusion.

In some embodiments, as shown in FIGS. 2 and 16, the third limiting member 530, through the cooperation between the third mating portion 1301 and the second protruding 522 of the second limiting member 520, may position the first protrusion 521 of the second limiting member 520 within the first groove 511, so that the rotating member 200 is in a positioned state relative to the housing 100., the third mating portion 1301 may also be referred to as a positioning structure, and the second protrusion 522 may also be referred to as a positioning block.

In some embodiments, as shown in FIGS. 3 and 17, the third limiting member 530, through the cooperation between the first mating portion 1302 and the second protruding 522 of the second limiting member 520, may position the first protrusion 521 of the second limiting member 520 outside the first groove 511, , thereby causing the rotating member 200 to rotate relative to the housing 100 to store the cable 300 in a retracted or storage state, and the first mating portion 1302 may also be referred to as a retracted structure.

In some embodiments, as shown in FIGS. 4 and 21, the second limiting member 520 may rotate the third limiting member 530 by means of the third protrusion 523, and the third protrusion 523 may also be referred to as a toggle block.

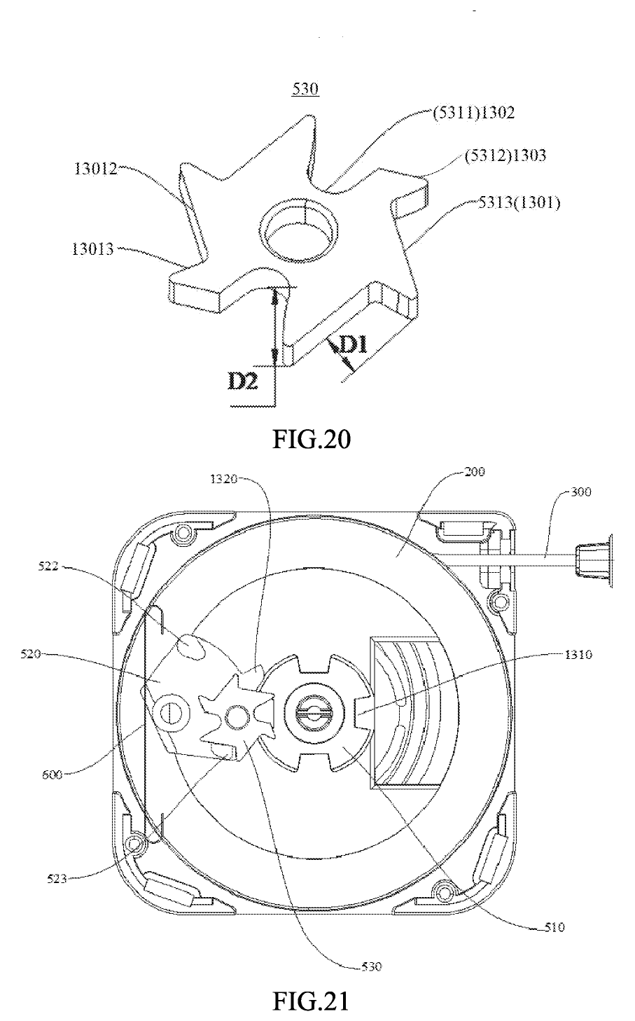

In some embodiments, as shown in FIGS. 12 and 20, the third mating portion 1301 may be a third groove 5313, the third groove 5313 may also be referred to as a positioning platform. The first mating portion 1302 may be a second groove 5311, the second groove 5311 is used to allow the first protrusion 521 to avoid the first groove 511, and the second groove 5311 may also be referred to as an avoidance groove.

In some embodiments, as shown in FIGS. 7 and 19, the second limiting member 520 is rotatably connected to the housing 100 via a third connecting column 135, and the third connecting column 135 may also be referred to as a second rotating shaft. The third limiting member 530 is rotatably connected to the housing 100 via a second connecting column 134, and the second connecting column 134 may also be referred to as a first rotating shaft.

As shown in FIG. 15, in some embodiments, the limiting assembly 500 is used to adjust the length of the cable 300 extending out of the housing 100.

As an example, as shown in FIG. 16, the mating structure may include a third mating portion 1301 for mating with the second protrusion 522 to lock the length of the cable 300 pulled out, and a first mating portion 1302 for rotating the rotating member 200 to retract the pulled-out cable 300. At least two third mating portions 1301 are consecutively arranged.

In some implementations of the present disclosure, the mating structure includes a third mating portion for engaging with the second protrusion to lock the length of the cable pull-out, and a first mating portion for rotating the rotating member to retract the pulled-out cable, and at least two third mating portions are consecutively arranged. By employing consecutively arranged third mating portions, allow for continuous positioning of the cable during the stretching process. The length stretched between two adjacent positioning intervals is smaller, enabling more precise length adjustment. When a single stretch length is insufficient to meet usage requirements, continuous stretching allows for rapid and accurate adjustment, optimizing product performance and improving user experience and convenience. The data cable device of the present disclosure also features multi-positioning functionality.

In some embodiments, as shown in FIG. 16, at least two third mating portions 1301 may be provided, and at least one first mating portion 1302 may be provided. The number of third mating portions 1301 is greater than the number of first mating portions 1302. Between two retractions of the cable 300, the second protrusion 522 engages with the third mating portion 1301 at least twice. During the stretching of the cable 300, the third mating portions 1301 in the limiting assembly 500 are continuously provided. Between the two engagements of the second protrusion 522 and the first mating portion 1302, the second protrusion 522 will engage with the continuously provided third mating portions 1301, thus performing multiple positioning of the cable 300 length, this reduces the length of the cable 300 stretched each time, allowing the user to adjust the length of the cable 300 more accurately.

By setting multiple continuous third mating portions between two retractions, the present disclosure may reduce the adjustable length for each positioning, thereby improving the accuracy of cable length adjustment, this allows users to make accurate adjustments according to their needs, improving the user experience and optimizing product performance.

In some embodiments, the mating structure may further include a second mating portion 1303 located between the first mating portion 1302 and the third mating portion 1301, the third protrusion 523 is used to cooperate with the third mating portion 1301 and the second mating portion 1303 to drive the third limiting member 530 to rotate, the second protrusion 522 is used to cooperate with the third mating portion 1301 to position and lock the rotating member 200 (as shown in FIG. 16), or the second protrusion 522 is used to cooperate with the first mating portion 1302 to make the rotating member 200 continuously rotate (as shown in FIG. 17).

During the rotation of the rotating member 200, the first limiting member 510 drives the second limiting member 520 to swing. The third protrusion 523 and the second protrusion 522 are disposed on the second limiting member 520, and the third protrusion 523 and the second protrusion 522 may swing along with the rotation of the second limiting member 520. During the swinging process of the third protrusion 523 and the second protrusion 522, the third protrusion 523 and the second protrusion 522 may alternately cooperate with the third limiting member 530. When the second protrusion 522 swings to cooperate with the third limiting member 530, it may achieve adjustment of extension or retraction. When the third protrusion 523 swings to cooperate with the third limiting member 530, it may actuate the third limiting member 530 to rotate (as shown in FIGS. 21 and 4), thus preparing for the next cooperation between the second protrusion 522 and the third limiting member 530.

When the second protrusion 522 cooperates with the third mating portion 1301, the counterclockwise rotation of the rotating member 200 is restricted, and the length of the cable 300 extending out is fixed. When the second protrusion 522 cooperates with the first mating portion 1302, the counterclockwise rotation of the rotating member 200 is unrestricted, and the cable 300 is retracted into the housing 100 as the rotating member 200 rotates. The cooperation between the third protrusion 523 and the third mating portion 1301 or the cooperation between the third protrusion 523 and the second mating portion 1303 may both rotate the third limiting member 530 by a certain angle, preparing for the next cooperation between the second protrusion 522 and the third mating portion 1301 or next cooperation between the second protrusion 522 and the first fitting part 1302.

In some embodiments, as shown in FIG. 20, the third mating portion 1301 is a third groove 5313 formed on the third limiting member 530, and the first mating portion 1302 is a second groove 5311 formed on the third limiting member 530. The distance between the bottom surface of the third groove 5313 and the center of the third limiting member 530 is greater than the distance between the bottom surface of the second groove 5311 and the center of the third limiting member 530. It may be understood that the third limiting member 530 is provided with multiple third grooves 5313 and second grooves 5311 circumferentially, the depth from the outer edge of the third limiting member 530 to the third groove 5313 is D1, and the depth from the outer edge of the third limiting member 530 to the bottom of the second groove 5311 is D2, D1 is less than D2. During the swinging process of the second limiting member 520, the second protrusion 522 may cooperate with the second groove 5311 or the third groove 5313, to switch the working state of the limiting assembly 500.

As shown in FIG. 16, when the limiting assembly 500 is in the positioned state, the second protrusion 522 cooperates with the third groove 5313. Since the limitation of the depth of the third groove 5313, the depth of the cooperation between the second protrusion 522 and the third limiting member 530 is relatively shallow, which restricts the second limiting member 520 from continuing to rotate with the first limiting member 510, the rotation angle of the second transmission structure 1320 is insufficient to avoid the first transmission structure 1310 on the first limiting member 510, which will hinder the first limiting member 510 from further counterclockwise rotation, the rotating member 200 will also be unable to continue to rotate counterclockwise, and the cable 300 cannot be retracted, the length of the cable 300 stretched out of the housing 100 is fixed, thereby playing a positioning role after the stretching position.

As shown in FIG. 17, when the limiting assembly 500 is in the retracted state, the second protrusion 522 cooperates with the second groove 5311, since the second groove 5311 is relatively deep, the second limiting assembly 520 rotates with the first limiting member 510 until the second protrusion 522 abuts the bottom of the second groove 5311, at this time, the rotation angle of the second transmission structure 1320 is sufficient to avoid the first transmission structure 1310 on the first limiting member 510, so that the first limiting member 510 may rotate counterclockwise without restriction, and the rotating member 200 may also move counterclockwise smoothly, thereby realizing the smooth retraction of the cable after it is stretched out.

By using different cooperation methods between the third limiting member and the second protrusion on the second limiting member, the present disclosure may control the angle of swing of the third limiting member, thereby achieving positioning of different gears, the structure is simple and easy to assemble.

In some embodiments, as shown in FIGS. 20 and 21, the third groove 5313 includes a first plane 13012 and a second plane 13013, and the length of the first plane 13012 is greater than the length of the second plane 13013. The third protrusion 523 at least abuts against the first plane 13012 to drive the second limiting member 520 to rotate, and the second protrusion 522 at least abuts against the first plane 13012 to limit the position of the second limiting member 520. When the second limiting member 520 swings until the third protrusion 523 contacts the third groove 5313, the third protrusion 523 may move along the first plane 13012 to push the third limiting member 530 to rotate. When the length of the first plane is set relatively long, it may ensure that the rotation angle of the third limiting member 530 may accurately match the second protrusion 522 and the third limiting member 530.

By limiting the length of the first plane of the third groove to be greater than the length of the second plane, the present disclosure may make the third groove have a longer contact area with the third projection, so that the third protrusion may be driven more accurately to ensure that the next third groove or the second groove may accurately cooperate with the second protrusion, so as to ensure that the function of the product may be realized smoothly and the product quality is improved.

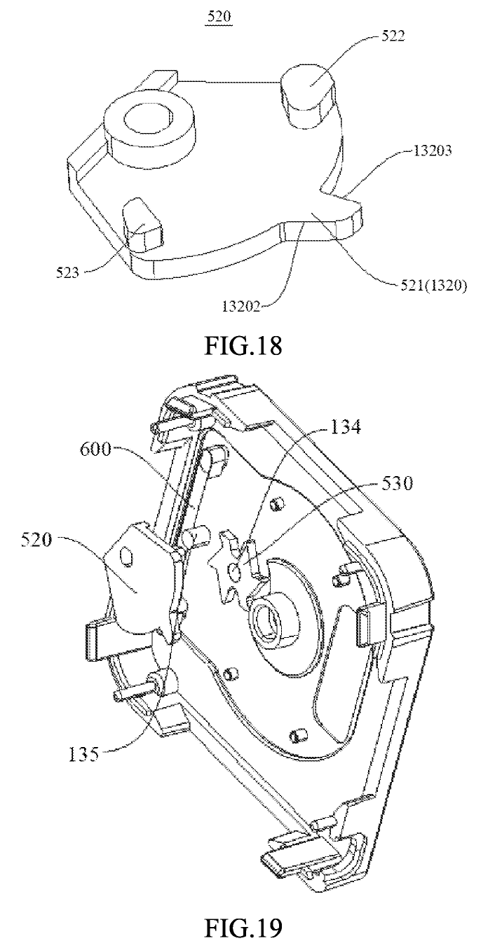

In some embodiments, as shown in FIGS. 18 and 20, the contour shape of at least the portion of the second protrusion 522 intended for insertion into the second groove 5311 is adapted to the contour shape of the second groove 5311. That is, when the limiting assembly 500 is in the retracted state, the second protrusion 522 may be inserted into the second groove 5311 and conform to the contour of the second groove 5311, allowing the second limiting member 520 to rotate through a sufficient angle to completely separate from the first limiting member 510, enabling the rotating member 200 to rotate smoothly.

The embodiment of the present disclosure sets the contour of the second groove to fit completely against the second protrusion, so that the rotating member is separated from the second limiting member as much as possible when rotating, without affecting the rotation of the rotating member, so that the cable may be retracted smoothly, thereby ensuring the reliability of the product function and optimizing the product quality.

In some embodiments, as shown in FIG. 17, a plurality of first grooves 511 are evenly distributed along the circumference of the first limiting member 510, and the first protrusion 521 cooperates with the first groove 511. When the limiting member 500 is in the positioned state, the first protrusion 521 abuts against the first groove 511, thus restricting the first limiting member 510 from further rotation. When the limiting member 500 is in the retracted state, the first protrusion 521 disengages from the first groove 511, thus allowing the first limiting member 510 to rotate without restriction, thereby realizing the retraction of the cable 300.

The embodiment of the present disclosure provides multiple first grooves on the first limiting member, so that the first protrusion 521 cooperates with the first grooves to limit the rotation of the rotating member. During the stretching process of the cable, the rotating member may achieve multiple positioning within one rotation, thereby improving the accuracy of cable length adjustment and further optimizing product performance.

In some embodiments, as shown in FIGS. 17 and 18, the first protrusion 521 has a transmission inclined surface 13202 and a limiting plane 13203, and the transmission inclined surface 13202 is inclined toward the direction of rotation when the first limiting member 510 is pulled out. It may be understood that the first protrusion 521 on the second limiting member 520 cooperates with the first groove 511 on the first limiting member 510. Each time the first protrusion 521 changes to a different first groove 511, the limiting assembly 500 performs a gear shift, the first limiting member 510 rotates by a corresponding angle with the rotating member 200, and the length of the cable 300 also extends or retracts by one gear. When the cable 300 is stretched outward, the extension direction of the transmission ramp 13202 of the first protrusion 521 is tangent to the outer edge of the first limiting member 510, and moves along the outer edge of the first limiting member 510. During this process, when the first protrusion 521 passes through the first groove 511, it will fall into the first groove 511 and restrict the first limiting member 510 from rotating further. When the limiting assembly 500 is in the positioned state, the limiting plane 13203 on the first protrusion 521 abuts against the first groove 511, restricting the first limiting member 510 from rotating further, meanwhile, when the first protrusion 521 falls into the first groove 511 for positioning, the first protrusion 521 and the inner wall of the first groove 511 may collide with each other and emit a prompt sound.

In the embodiments of the present disclosure, the gear shift is achieved through the cooperation of the first protrusion and the first groove, the setting of the limiting plane and the transmission inclined surface ensures the smooth operation of the cable winder. Furthermore, an audible prompt is emitted during gear shifting to remind the user that a gear shift has been completed, thus improving product quality and enhancing the user experience.

In some embodiments, the data cable device is a cable winder, the rotating member is a wheel core, the limiting assembly is an adjusting assembly, the cable is a wire, the accommodating space is an accommodating cavity, the first elastic member is an elastic member such as a coil spring or a clockwork, the third limiting member is a first adjusting member, the first limiting member is a drive wheel, the second limiting member is a second adjusting member, the first groove is a transmission groove, the second connecting column is a first rotating shaft, the third mating portion is a positioning structure, the first mating portion is a retraction structure, the third connecting column is a second rotating shaft, the elastic assembly is an elastic member, the third protrusion is a toggle block, the second protrusion is a positioning block, the first protrusion is a transmission protrusion, the third groove is a positioning platform, and the second groove is an avoidance groove.

As shown in FIG. 15, the embodiment of the present disclosure provides a cable winder (data cable device) 1 with multi-gears positioning, the cable winder includes a housing 100, a wheel core (rotating member) 200, and an adjustment assembly (limiting assembly) 500. The housing 100 has an accommodating cavity (accommodating space) 101 for accommodating a cable 300, and the housing 100 defines an opening 102 for the cable 300 to pass through. The opening 102 communicates with the accommodating cavity (accommodating space) 101. The wheel core (rotating member) 200 is disposed in the accommodating cavity (accommodating space) 101 and is movably connected to the housing 100. The cable 300 is wound around the wheel core (rotating member) 200, and the wheel core (rotating member) 200 may rotate as the cable 300 is pulled out or retracted. A portion of the adjustment assembly (limiting assembly) 500 is mounted on the housing 100, and the adjustment assembly (limiting assembly) 500 is used to adjust the length of the cable 300 extending out of the housing 100.

The wheel core (rotating assembly) 200 is internally equipped with an elastic member (first elastic member) 400, such as a coil spring or a clockwork. Under the action of the external force, the wheel core (rotating member) 200 rotates, causing the elastic member (first elastic member) 400 to undergo elastic deformation. After the external force is removed, the elastic member (first elastic member) 400 returns to its original deformation, and the resulting driving force may drive the wheel core (rotating member) 200 to rotate. The cable 300 is wound around the wheel core (rotating member) 200 and is disposed together with the wheel core (rotating member) 200 in the accommodating cavity (accommodating space) 101 within the housing 100. The cable 300 extends out of the housing 100 through the opening 102. When the cable 300 is stretched under the external force, its movement exerts a force on the wheel core (rotating member) 200, causing it to rotate clockwise. When the external force on the cable 300 is removed, the wheel core (rotating member) 200 rotates counterclockwise, and the cable 300 retracts with the counterclockwise rotation of the wheel core (rotating member) 200. The adjusting assembly (limiting assembly) 500 may partially abut against the wheel core (rotating member) 200. During rotation, the wheel core (rotating member) 200 drives the adjusting assembly (limiting assembly) 500 to move, thus limiting the rotation of the wheel core (rotating member) 200 and adjusting the length of the cable 300 extending out of the housing 100.

As an example, as shown in FIG. 16, the adjustment assembly (limiting assembly) 500 includes a first adjusting member (third limiting member) 530. The first adjusting member (third limiting member) 530 includes a positioning structure (third mating portion) 1301 for cooperating with the wheel core (rotating member) 200 to lock the length of the pulled-out cable 300, and a retraction structure (first mating portion) 1302 for rotating the wheel core (rotating member) 200 to retract the pulled-out cable 300. At least two positioning structures (third mating portions) 1301 are continuously provided. That is, the adjustment assembly (limiting assembly) 500 is provided with positioning structures (third mating portions) 1301 and retraction structures (first mating portions) 1302. During the process of the cable 300 stretching and driving the wheel core (rotating member) 200 to rotate, the wheel core (rotating member) 200 will cooperate with the positioning structure (third mating portion) 1301 or the retraction structure (first mating portion) 1302 on the adjustment assembly (limiting assembly) 500.

The cooperation between the positioning structure (third mating portion) 1301 and the wheel core (rotating member) 200 may include indirect cooperation between the positioning structure (third mating portion) 1301 and the wheel core (rotating component) 200. For example, the positioning structure (third mating portion) 1301 may engage with another structural member on the wheel core (rotating member) 200 through one structural member; the cooperation between the wheel core (rotating member) 200 and the retraction structure (first mating portion) 1302 may be indirect cooperation between the wheel core (rotating member) 200 and the retraction structure (first mating portion) 1302, for example, one structural member on the wheel core (rotating member) 200 engages with the retraction structure (first mating portion) 1302 through another structural member.

As an example, as shown in FIG. 16, when the wheel core (rotating member) 200 engages with the positioning structure (third mating portion) 1301, the reverse rotation of the wheel core (rotating member) 200 is restricted, and the length of the cable 300 extending out of the housing 100 is fixed, thereby positioning the cable 300. As shown in FIG. 17, when the wheel core (rotating member) 200 engages with the retraction structure (first mating portion) 1302, the reverse rotation of the wheel core (rotating member) 200 is unrestricted, and the portion of the cable 300 extending out of the housing 100 retracts into the housing 100 as the wheel core (rotating member) 200 rotates in the reverse direction, thereby retracting the cable 300. Since at least two positioning structures (third mating portions) 1301 are continuously provided in the adjustment assembly (limiting assembly) 500, the wire (cable) 300 may be continuously positioned during the stretching process. If the length of one stretching is not enough to meet the user's needs, it may be stretched again and positioned until the appropriate length of the wire (cable) 300 is adjusted.

In some embodiments, a cable winder (data cable device) with multi-gears positioning is provided in the present disclosure, and the cable winder includes a housing, a wheel core (rotating member), and an adjustment assembly (limiting assembly). The housing has an internal cavity (accommodating space) for accommodating the cable, and an opening for the cable to pass through, the opening communicates with the cavity (accommodating space). The wheel core (rotating member) is disposed within the cavity (accommodating space) and is movably connected to the housing. The cable is wound around the wheel core (rotating member), and the wheel core (rotating member) may rotate as the cable is pulled out or retracted. A portion of an adjusting assembly (limiting assembly) is mounted on the housing. The adjusting assembly (limiting assembly) is used to adjust the length of the cable extending out of the housing. The adjusting assembly (limiting assembly) includes a positioning structure (third mating portion) for engaging with the wheel core (rotating member) to lock the length of the cable pulled out, and a retraction structure (first mating portion) for rotating the wheel core (rotating member) to retract the pulled-out cable. At least two positioning structures (third mating portions) are continuously provided. Based on this design, through the use of a continuously positioned positioning structure (third mating portion), allows the cable to be continuously positioned during the stretching process. The length stretched between two adjacent positioning is smaller, enabling more precise length adjustment. If the length stretched in one stretch is insufficient to meet the usage requirements, continuous stretching can achieve rapid and accurate adjustment, optimizing product performance and improving user experience and convenience.

In some embodiments, as shown in FIG. 16, at least two positioning structures (third mating portions) 1301 are provided, and at least one retraction structure (first mating portion) 1302 is provided. The number of positioning structures (third mating portions) 1301 is greater than the number of retraction structures (first mating portions) 1302. Between two retractions of the cable 300, the wheel core (rotating member) 200 engages with the positioning structures (third mating portions) 1301 at least twice. During the stretching process of the cable 300, the positioning structures (third mating portions) 1301 in the adjusting assembly (limiting assembly) 500 are continuously arranged. Between the two cooperations between the wheel core (rotating member) 200 and the retraction structure (first mating portion) 1302, the wheel core (rotating member) 200 will engage with the continuously arranged positioning structures (third mating portions) 1301, performing multiple positioning on the length of the cable 300, this reduces the length of the cable 300 stretched each time, allowing the user to adjust the length of the cable 300 more accurately.

By setting multiple continuous positioning structures between two retractions, the present disclosure may reduce the adjustable length for each positioning, thereby improving the accuracy of cable length adjustment, this allows users to make accurate adjustments according to their needs, improving the user experience and optimizing product performance.

In some embodiments, as shown in FIGS. 15 and 16, the cable winder (data cable device) may further include an elastic member (first elastic member) 400 such as a coil spring or spring- shaped coil, and the elastic member may be connected to the wheel core (rotating member) 200 and the housing 100 respectively by means of bonding, snap-fitting, welding, etc. The elastic member (first elastic member) 400 is used to generate a driving force for the wheel core (rotating member) 200 to retract the cable. The adjusting assembly (limiting assembly) 500 may further include a drive wheel (first limiting member) 510, and the drive wheel is connected to the wheel core (rotating member) 200 to follow the rotation of the wheel core (rotating member) 200. The drive wheel (first limiting member) 510 is provided with a first transmission structure 1310 that is partially connected to the adjusting assembly (limiting assembly) 500, to drive the partial movement of the adjusting assembly (limiting assembly) 500. It is understood that a spring (first elastic member) 400 is provided in the wheel core (rotating member) 200, and the cable 300 is wound on the wheel core (rotating member) 200. When the cable 300 is stretched, it will drive the wheel core (rotating member) 200 to rotate in the forward direction. At this time, the spring (first elastic member) 400 in the wheel core (rotating member) 200 will deform. When the external force is removed, the spring (first elastic member) 400 will restore its deformation, so as to drive the wheel core (rotating member) 200 to rotate in the reverse direction, thereby driving the cable 300 to retract. The drive wheel (first limiting member) 510 is fixed on the wheel core (rotating member) 200 and rotates with the rotation of the wheel core (rotating member) 200. The first transmission structure 1310 on the drive wheel (first limiting member) 510 may cooperate with a part of the adjustment assembly (limiting assembly) 500. During the rotation of the drive wheel (first limiting member) 510 with the wheel core (rotating member) 200, the first transmission structure 1310 may drive a part of the adjustment assembly (limiting assembly) 500 to move. During the movement, the rotation of the drive wheel (first limiting member) 510 is controlled by a part of the adjustment assembly (limiting assembly) 500, thereby limiting the rotation of the wheel core (rotating member) 200 to achieve the stretching or retraction of the cable 300.

The embodiment of the present disclosure provides a drive wheel (first limiting member) on the wheel core (rotating member) and a first transmission structure on the drive wheel (first limiting member) that partially cooperates with the adjustment assembly (limiting assembly), the first transmission structure drives the adjustment assembly (limiting assembly) to rotate, thereby enabling the extension and retraction of the cable, this method offers good transmission reliability, simplifies the structure of the wheel core (rotating member), facilitates assembly, and improves production efficiency.

In some embodiments, as shown in FIGS. 17 and 18, the adjustment assembly (limiting assembly) 500 further includes a second adjusting member (second limiting member) 520, a toggle block (third protrusion) 523, and a positioning block (second protrusion) 522. The second adjusting member (second limiting member) 520 is connected to the housing 100 via the second rotating shaft (third connecting column) 135 (as shown in FIG. 19), and the second transmission structure 1320 is provided on the second adjusting member (second limiting member) 520. The first transmission structure 1310 and the second transmission structure 1320 cooperate to transmit power and limit the angle through which the drive wheel (first limiting member) 510 rotates. The first adjusting member (third limiting member) 530 is rotatably connected to the housing 100 via the first rotating shaft (second connecting column) 134 (as shown in FIG. 19). The positioning structure (third mating portion) 1301 and the retraction structure (first mating portion) 1302 are both provided on the first adjusting member (third limiting member) 530. The first adjusting member (third limiting member) 530 also includes components located circumferentially on the retraction structure (first mating portion) 1302 and the positioning structure (third mating portion) 1301. The second mating portion 1303 is between the two parts; the toggle block (third protrusion) 523 is disposed on the second adjusting member (second limiting member) 520. The toggle block (third protrusion) 523 is used to cooperate with the positioning structure (third mating portion) 1301 and the second mating portion 1303 to drive the first adjusting member (third limiting member) 530 to rotate. The positioning block (second protrusion) 522 is disposed on the second adjusting member (second limiting member) 520 and spaced apart from the toggle block (third protrusion) 523. The positioning block (second protrusion) 522 is used to cooperate with the positioning structure (third mating portion) 1301 to position and lock the position of the wheel core (rotating member) 200 (as shown in FIG. 16), or the positioning block (second protrusion) 522 is used to cooperate with the retraction structure (first mating portion) 1302 to make the wheel core (rotating member) 200 continuously rotate (as shown in FIG. 17).

The adjustment assembly (limiting assembly) 500 has a second adjusting member (second limiting member) 520 and a first adjusting member (third limiting member) 530. The second adjusting member (second limiting member) 520 is connected to the housing 100 through a second rotating shaft (third connecting column) 135, and has a second transmission structure 1320 that may cooperate with the first transmission structure 1310. During the rotation of the wheel core (rotating member) 200, the first transmission structure 1310 drives the second transmission structure 1220, thereby causing the second adjusting member (second limiting member) 520 to swing. The toggle block (third protrusion) 523 and the positioning block (second protrusion) 522 are disposed on the second adjusting member (second limiting member) 520. The toggle block (third protrusion) 523 and the positioning block (second protrusion) 522 may swing with the rotation of the adjusting member. The first adjusting member (third limiting member) 530 is connected to the housing 100 through the first rotating shaft (second connection) 134 and is located between the toggle block (third protrusion) 523 and the positioning block (second protrusion) 522. During the swinging process of the toggle block (third protrusion) 523 and the positioning block (second protrusion) 522 with the second adjusting member (second limiting member) 520, the toggle block (third protrusion) 523 and the positioning block (second protrusion) 522 may cooperate with the first adjusting member (third limiting member) 530. When the positioning block (second protrusion) 522 swings to engage with the first adjusting member (third limiting member) 530, it may extend or retract. When the toggle block (third protrusion) 523 swings to engage with the first adjusting member (third limiting member) 530, it may actuate the first adjusting member (third limiting member) 530 to rotate (as shown in FIGS. 21 and 4), preparing for the next cooperation of the positioning block (second protrusion) 522 with the first adjusting member (third limiting member) 530.

Since both the positioning structure (third mating portion) 1301 and the retraction structure (first mating portion) 1302 are provided on the first adjusting member (third limiting member) 530, when the positioning block (second protrusion) 522 is cooperated with the positioning structure (third mating portion) 1301, the counterclockwise rotation of the wheel core (rotating member) 200 is restricted, and the length of the cable 300 is fixed; when the positioning block (second protrusion) 522 is cooperated with the retraction structure (first mating portion) 130, the counterclockwise rotation of the wheel core (rotating member) 200 is unrestricted, and the cable 300 is retracted into the housing 100 as the wheel core (rotating member) 200 rotates. The toggle block (third protrusion) 523, when cooperated with the positioning structure (third mating portion) 1301 or the second mating portion 1303, may actuate the first adjusting member (third limiting member) 530 to rotate a certain angle, preparing for the next cooperation between the positioning block (second protrusion) 522 and the positioning structure (third mating portion) 1301 or the next cooperation between the positioning block (second protrusion) 522 and the retraction structure (first mating portion) 1302.

The embodiment of the present disclosure utilizes the cooperation between the second adjusting member (second limiting member) and the positioning block (second protrusion) and the toggle block (third protrusion) on the first adjusting member (third limiting member) to enable accurate gear switching during the stretching process of the cable, thereby preventing the cable winder (data cable device) from malfunctioning, optimizing product quality, and further improving the user experience.

In some embodiments, as shown in FIG. 16, the adjusting assembly (limiting assembly) 500 further includes an elastic member (elastic assembly) 600. The elastic member (elastic assembly) 600 is mounted on the housing 100 and the elastic member abuts against the second adjusting member (second limiting member) 520 to drive the second adjusting member (second limiting member) 520 to oscillate back and forth around the second rotating shaft (third connecting column) 135.

As shown in FIGS. 16 to 18, during the rotation of the drive wheel (first limiting member) 510, the second adjusting member (second limiting member) 520 swings along with the rotation of the drive wheel (first limiting member) 510. The elastic member (elastic assembly) 600 is installed on the inner wall of the housing 100, and the elastic member is located on the side of the second adjusting member (second limiting member) 520 away from the drive wheel (first limiting member) 510, after the second adjusting member (second limiting member) 520 rotates at a certain angle, the elastic member (elastic assembly) 600 restricts the rotation of the second adjusting member (second limiting member) 520, so that the second adjusting member (second limiting member) 520 may return to its original position in time after rotation.

By setting up the elastic member (elastic assembly) and controlling the swing angle of the second adjusting member (second limiting member), the present disclosure prevents the second adjusting member (second limiting member) from rotating too much and failing to return to its original position in time, thus ensuring the normal operation of the gear adjustment function, improving product quality, and optimizing product performance.

In some embodiments, as shown in FIG. 20, the positioning structure (third mating portion) 1301 is a positioning platform (third groove) 5313 formed on the first adjusting member (third limiting member) 530, and the retraction structure (first mating portion) 1302 is an avoidance groove (second groove) 5311 formed on the first adjusting member (third limiting member) 530. The distance between the bottom surface of the positioning platform (third groove) 5313 and the center of the first adjusting member (third limiting member) 530 is greater than the distance between the bottom surface of the avoidance groove (second groove) 5311 and the center of the first adjusting member (third limiting member) 530. The first adjusting member (third limiting member) 530 is provided with multiple positioning platforms (third grooves) 5313 and avoidance grooves (second grooves) 5311 along the circumference. The depth from the outer edge of the first adjusting member (third limiting member) 530 to the positioning platform (third groove) 5313 is D1, and the depth from the outer edge of the first adjusting member (third limiting member) 530 to the bottom of the avoidance groove (second groove) 5311 is D2, and D1 is less than D2. During the swinging process of the second adjusting member (second limiting member) 520, the positioning block (second protrusion) 522 may cooperate with the avoidance groove (second groove) 5311 or the positioning platform (third groove) 5313 to realize the switching of the working state of the adjusting assembly (limiting assembly) 500.

As shown in FIG. 16, when the adjusting assembly (limiting assembly) 500 is in the positioned state, the positioning block (second protrusion) 522 cooperates with the positioning platform (third groove) 5313, since the limitation of the depth of the positioning platform (third groove) 5313, the positioning block (second protrusion) 522 cooperates with the first adjusting member (third limiting member) 530 at a shallow depth, which limits the second adjusting member (second limiting member) 520 from continuing to rotate with the drive wheel (first limiting member) 510, at this time, the rotation angle of the second transmission structure 1320 is insufficient to avoid the first transmission structure 1310 on the drive wheel (first limiting member) 510, which will hinder the drive wheel (first limiting member) 510 from further counterclockwise rotation. The wheel core (rotating member) 200 will also be unable to continue to rotate counterclockwise, and the cable 300 cannot be retracted, and the length of the cable 300 stretched out of the housing 100 is fixed, thereby playing a positioning role after the stretching position.

As shown in FIG. 17, when the adjusting assembly (limiting assembly) 500 is in the retracted state, the positioning block (second protrusion) 522 cooperates with the avoidance groove (second groove) 5311,since the avoidance groove (second groove) 5311 has a large depth, the second adjusting member (second limiting member) 520 rotates with the drive wheel (first limiting member) 510 until the positioning block (second protrusion) 522 abuts the bottom of the avoidance groove (second groove) 5311 and then stops, at this time, the rotation angle of the second transmission structure 1320 is sufficient to avoid the first transmission structure 1310 on the drive wheel (first limiting member) 510, so that the drive wheel (first limiting member) 510 may rotate counterclockwise without restriction, and the wheel core (rotating member) 200 may also move counterclockwise smoothly, thereby realizing the smooth retraction of the cable after it is stretched out.

By using different cooperation methods between the positioning block (second protrusion) on the first adjusting member (third limiting member) and the second adjusting member (second limiting member), the present disclosure may control the angle of swing of the third limiting member, thereby achieving positioning of different gears, the structure is simple and easy to assemble.

In some embodiments, as shown in FIGS. 20 and 21, the positioning platform (third groove) 5313 includes a first plane 13012 and a second plane 13013, and the length of the first plane 13012 is greater than the length of the second plane 13013. The actuating block (third protrusion) 523 at least abuts against the first plane 13012 to drive the second adjusting member (second limiting member) 520 to rotate, and the positioning block (second protrusion) 522 at least abuts against the first plane 13012 to define the position of the second adjusting member (second limiting member) 520. When the second adjusting member (second limiting member) 520 swings until the toggle block (third protrusion) 523 contacts the positioning table (third groove) 5313, the toggle block (third protrusion) 523 may move along the first plane 13012 to push the first adjusting member (third limiting member) 530 to rotate. When the length of the first plane 13012 is set to be relatively long, it may be ensured that the rotation angle of the first adjusting member (third limiting member) 530 can meet the accurate matching of the positioning block (second protrusion) 522 and the first adjusting member (third limiting member) 530.

This embodiment of the invention limits the length of the first plane of the positioning platform (third groove) to be greater than the length of the second plane, so that the positioning platform (third groove) and the actuating block (third protrusion) have a longer contact area, making the driving of the toggle block (third protrusion) more accurate, ensuring that the next positioning platform (third groove) or the avoidance groove (second groove) can accurately cooperate with the positioning block (second protrusion), ensuring the smooth realization of product functions and improving product quality. By limiting the length of the first plane of the positioning platform (third groove) to be greater than the length of the second plane, the present disclosure may make the positioning platform (third groove) have a longer contact area with the toggle block (third protrusion), so that the third protrusion may be driven more accurately to ensure that the next positioning platform (third groove) or the avoidance groove (second groove) may accurately cooperate with the second protrusion, so as to ensure that the function of the product may be realized smoothly and the product quality is improved.

In some embodiments, as shown in FIGS. 18 and 20, the contour shape of at least the portion of the positioning block (second protrusion) 522 used for insertion into the avoidance groove (second groove) 5311 is adapted to the contour shape of the avoidance groove (second groove) 5311. When the adjusting assembly (limiting assembly) 500 is in the retracted state, the positioning block (second protrusion) 522 may be inserted into the avoidance groove (second groove) 5311 and fit against the contour of the avoidance groove (second groove) 5311, so that the second adjusting member (second limiting member) 520 rotates through a sufficient angle to completely separate from the drive wheel (first limiting member) 510, so that the wheel core (rotating member) 200 may rotate smoothly.

The embodiment of the present disclosure sets the contour of the avoidance groove (second groove) to fit completely with the positioning block (second protrusion), so that the wheel core (rotating member) is separated from the second adjusting member (second limiting member) as much as possible when rotating, without affecting the rotation of the wheel core (rotating member), so that the cable may be smoothly retracted, thereby ensuring the reliability of product function and optimizing product quality.

In some embodiments, as shown in FIG. 21, the first transmission structure 1310 is a transmission groove (first groove) 511 formed on the drive wheel (first limiting member) 510, and multiple transmission grooves (first grooves) 511 are evenly arranged. The first transmission structure 1310 is a transmission groove (first groove), and multiple transmission grooves (first grooves) 511 are evenly distributed along the circumference of the drive wheel (first limiting member) 510, the second transmission structure 1320 cooperates with the transmission groove (first groove) 511. When the adjusting assembly (limiting assembly) 500 is in the positioned state, the second transmission structure 1320 abuts against the transmission groove (first groove) 511, restricting the drive wheel (first limiting member) 510 from rotating further. When the adjusting assembly (limiting assembly) 500 is in the retracted state, the second transmission structure 1320 disengages from the transmission groove (first groove) 511, allowing the drive wheel (first limiting member) 510 to rotate without restriction, thereby realizing the retraction of the cable 300.

The embodiment of the present disclosure provides multiple transmission grooves (first grooves) on the drive wheel (first limiting member), so that the second transmission structure cooperates with the transmission grooves (first grooves) to limit the rotation of the wheel core (rotating member). During the stretching process of the cable, the wheel core (rotating member) may achieve multiple positioning within one rotation, thereby improving the accuracy of cable length adjustment and further optimizing product performance.

In some embodiments, as shown in FIGS. 17 and 18, the second transmission structure 1320 is a transmission protrusion (first protrusion) 521 disposed on the edge of the second adjusting member (second limiting member) 520, the transmission protrusion (first protrusion) 521 has a transmission inclined surface 13202 and a limiting plane 13203, and the transmission inclined surface 13202 is inclined toward the direction of rotation when the drive wheel (first limiting member) 510 is pulled out. The transmission protrusion (first protrusion) 521 on the second adjusting member (second limiting member) 520 cooperates with the transmission groove (first groove) 511 on the drive wheel (first limiting member) 510. Each time the transmission protrusion (first protrusion) 521 changes to a new cooperating transmission groove (first groove) 511, the adjusting assembly (limiting assembly) 500 performs a gear shift, and the drive wheel (first limiting member) 510 rotates by a corresponding angle with the wheel core (rotating member) 200, and the length of the cable 300 also extends or retracts by one gear. When the cable 300 is stretched outward, the extension direction of the transmission inclined surface 13202 of the transmission protrusion (first protrusion) 521 is tangent to the outer edge of the drive wheel (first limiting member) 510 and moves along the outer edge of the drive wheel (first limiting member) 510. During this process, when the transmission protrusion (first protrusion) 521 passes through the transmission groove (first groove) 121, it will fall into the transmission groove (first groove) 121 and restrict the drive wheel (first limiting member) 510 from rotating further. When the adjusting assembly (limiting assembly) 500 is in the positioned state, the limiting plane 13203 on the transmission protrusion (first protrusion) 521 abuts against the transmission groove (first groove) 511, restricting the drive wheel (first limiting member) 510 from rotating further. Meanwhile, when the transmission protrusion (first protrusion) 521 falls into the transmission groove (first groove) 121 for positioning, the transmission protrusion (first protrusion) 521 and the inner wall of the transmission groove (first groove) 511 may collide with each other and emit a prompt sound.

The embodiment of the present disclosure sets the second transmission structure as a transmission protrusion (first protrusion), and achieves gear switching through the cooperation of the transmission protrusion (first protrusion) and the transmission groove (first groove), and the setting of the limiting plane and the transmission inclined plane ensures the realization of the cable winder (data cable device). In this embodiment, a prompt sound is emitted when switching gears thereby reminding the user that a gear switch has been completed, thereby improving product quality and enhancing the user experience.

The above description is merely a specific embodiment of the present disclosure, but the scope of protection of the present disclosure is not limited thereto. Any variations or substitutions that may be easily conceived by those skilled in the art within the scope of the technology disclosed in the present disclosure should be included within the scope of protection of the present disclosure. Therefore, the scope of protection of the present disclosure should be determined by the scope of the claims.

What is claimed is:

1. A data cable device comprising:
a housing comprising an accommodating space and an opening communicating with the accommodating space;
a rotating member rotatably disposed in the accommodating space and configured to coil a cable, wherein the opening of the housing is configured to receive a portion of the cable extending out of the rotating member such that the cable extends out of the housing via the opening;
a first elastic member disposed between the rotating member and the housing, and the first elastic member configured to drive the rotating member to rotate in a retraction direction; and
a limiting assembly comprising a first limiting member, a second limiting member, a third limiting member and a reset assembly, wherein
the first limiting member is disposed at one end of the rotating member, the first limiting member defines at least one first groove on a periphery side of the first limiting member;
the second limiting member is rotatably disposed in the housing; a periphery of the second limiting member comprises a first protrusion configured for cooperating with the first groove, an end surface of the second limiting member further comprises a second protrusion and a third protrusion disposed at intervals;
the third limiting member is rotatably disposed on the housing and is located between the second protrusion and the third protrusion, a peripheral side of the third limiting member comprises at least one set of mating structures configured for cooperating with the second protrusion and the third protrusion, the second limiting member is configured to push the third limiting member to rotate through the at least one set of mating structures; and
the reset assembly disposed between the second limiting member and the housing, wherein the reset assembly is configured to provide a force to the second limiting member to position the first protrusion within the first groove, so as to cooperate with the mating structure to position the second limiting member in a positioned state where the first protrusion is within the first groove.

2. The data cable device according to claim 1, wherein the data cable device further comprises a stretched state and a retracted state;
in the stretched state, the reset assembly drives the second limiting member to rotate in a first direction, and the first protrusion is located outside the first groove;
in the retracted state, the reset assembly drives the second limiting member to rotate in a second direction, and the first protrusion is located outside the first groove;
in the positioned state, the reset assembly drives the second limiting member to rotate in the second direction, and the first protrusion is located inside the first groove,
wherein the second direction is opposite to the first direction, and the second direction is the same as the retraction direction.

3. The data cable device according to claim 2, wherein the reset assembly comprises a second elastic member and a third elastic member;
the second elastic member is configured to drive to the second limiting member to rotate in the second direction;
the third elastic member is configured to drive the second limiting member to rotate in the first direction.

4. The data cable device according to claim 3, wherein the second elastic member and the third elastic member are disposed on the housing, the second elastic member and the third elastic member are located on opposite sides of the second limiting member, respectively, and each of the second elastic member and the third elastic member is configured to contact the second limiting member; wherein a first end of the second elastic member is connected to the housing, and a second end of the second elastic member is configured to contact the second limiting member; a first end of the third elastic member is connected to the housing, and a second end of the third elastic member is configured to contact the second limiting member.

5. The data cable device according to claim 4, wherein a peripheral of the second limiting member comprises a first concave portion and a second concave portion, the first concave portion and the second concave portion are oppositely arranged on a circumferential side of the second limiting member, and the first concave portion and the second concave portion are further arranged relative to each other; the second end of the second elastic member is located in the first concave portion, and the second end of the third elastic member is located in the second concave portion; the second end of the second elastic member comprises a first contact arc surface, a first contact plane and a second contact plane located on sides of the first contact arc surface, respectively, the second end of the third elastic member comprises a second contact arc surface, a third contact plane and a fourth contact plane located on sides of the second contact arc surface, respectively.

6. The data cable device according to claim 5, wherein the housing comprises a first wall, the second limiting member and the third limiting member are disposed on the first wall, and the second elastic member and the third elastic member are respectively connected to one side of the first wall facing the accommodating space; on a projection plane parallel to a rotation axis, a projection area of the second elastic member and a projection area of the third elastic member are located outside a projection area of the first wall on the projection plane; wherein the first wall defines a first slot and a second slot, the first slot communicates with the accommodating space and corresponds to a position of the second elastic member; the second slot communicates with the accommodating space and corresponds to a position of the third elastic member; on a projection plane perpendicular to the rotation axis, a contour line of the first slot is adjacent to a portion of a contour line of the second elastic member, and a contour line of the second slot is adjacent to a portion of a contour line of the third elastic member.

7. The data cable device according to claim 6, wherein the first wall, the second elastic member, and the third elastic member are parts of a same structure ; or wherein the first wall, the second elastic member, and the third elastic member are separate structures.

8. The data cable device according to claim 1, wherein the second limiting member further comprises a first structural portion and a second structural portion,
the first structural portion is rotatably connected to the housing; the reset assembly is disposed between the first structural portion and the housing;
a first side of the second structural portion is connected to the first structural portion, a second side of the second structural portion comprises the first protrusion, and the second protrusion and the third protrusion are located on an end surface of the second structural portion;
wherein a first portion of the first structural portion protrudes axially from the end surface of the second structural portion, and the third limiting member is located in a space defined by the first portion of the first structural portion, the second protrusion, and the third protrusion; and
wherein the second protrusion, the third protrusion, and the first portion of the first structural portion have a same axial height or a similar axial height.

9. The data cable device according to claim 1, wherein the at least one set of mating structures comprises a first mating portion, a second mating portion, and a third mating portion arranged adjacent to each other along a circumference of the third limiting member; the first mating portion and the third mating portion are configured to cooperate with the second protrusion; the second mating portion is configured to cooperate with the third protrusion;
wherein a distance between the first mating portion and an axis is smaller than a distance between the third mating portion and the axis;
in the stretched state, the second mating portion engages with the third protrusion;
in the positioned state, the second protrusion contacts the third mating portion; and
in the retracted state, the second protrusion engages with the first mating portion;
wherein the first mating portion comprises a second groove, the second mating portion comprises a first side surface, and the third mating portion comprises a third groove; the second groove and the third groove are configured to cooperate with the second protrusion, the first side surface is configured to cooperate with a second side surface of the third protrusion;
wherein a depth of the second groove is greater than a depth of the third groove;
in a stretched state, the first side surface and the second side surface are arranged adjacent to each other;
in a positioned state, the second protrusion is located in the third groove; and
in the retracted state, the second protrusion is located in the second groove;
wherein a peripheral side of the third limiting member further comprises a protrusion structure located between the second groove and the third groove, and the first side surface is located on one side of the protrusion structure facing the second groove.

10. The data cable device according to claim 1, wherein the third limiting member comprises three sets of mating structures, and the three sets of mating structures are evenly distributed along a circumference of the third limiting member.

11. The data cable device according to claim 1, wherein the second protrusion and the third protrusion have a same axial height or a similar axial height.

12. The data cable device according to claim 2, wherein:
in the stretched state, the reset assembly is configured to provide a force for the second limiting member to rotate in the first direction, so that the first protrusion is located within the first groove, and the mating structure is configured to cooperate with the second protrusion to position the second limiting member in the positioned state where the first protrusion is located in the first groove.

13. The data cable device according to claim 1, wherein an axis of the third limiting member is parallel to an axis of the second limiting member, an end surface of the third limiting member is disposed adjacent to an end surface of the second limiting member, and the third limiting member and the second protrusion have the same or similar axial height.

14. The data cable device according to claim 1, wherein an axial thickness of the third limiting member is uniformly, and the at least one set of mating structures is arranged along a circumference of the third limiting member.

15. The data cable device according to claim 9, wherein a shape of an insertion end of the second protrusion matches a shape of the second groove, the end surface of the insertion end of the second protrusion is configured to contact a bottom surface of the second groove of the first mating portion, a first included angle between two sides of the insertion end of the second protrusion is less than 45 degrees, a second included angle between two sides of the third groove of the third mating portion is greater than 90 degrees, and the end surface of the insertion end of the second protrusion is further configured to contact a side surface of the third groove; wherein the first included angle ranges from 39 degrees to 41 degrees, the second included angle ranges from 100 degrees to 105 degrees, and a third included angle between two sides of the second groove ranges from 40 degrees to 42 degrees.

16. The data cable device according to claim 1, wherein the rotating member comprises a winding portion and a baffle portion in an axial direction of the rotating member, and the winding portion is adjacent to the baffle portion; wherein:
a portion of the cable is coiled outside the winding portion and the portion of the cable is capable of extending outward from the housing via the opening;
the first elastic member is disposed between the winding portion and the housing;
the first limiting member is disposed at one end of the baffle portion away from the winding portion;
wherein the first limiting member and the rotating member are parts of a same structure; or wherein the first limiting member and the rotating member are separate structures.

17. The data cable device according to claim 1, wherein each mating structure of the at least one set of mating structures comprises a first mating portion and a third mating portion, the third mating portion is configured to cooperate with the second protrusion to lock a length of the cable to be pulled out of the data cable device, and the first mating portion is configured to rotate the rotating member to retract the cable been pulled out, wherein, as the rotating member rotating, the third liming member rotates, driven by the second liming member, such that at least two third mating portions continuously lock the length of the cable; and wherein at least two third mating portions are continuously provided, and at least one first mating portion is provided; wherein a number of the third mating portions is greater than a number of the first mating portions, and the second protrusion cooperates with the third mating portion at least twice between two consecutive retractions of the cable by the rotating member.

18. The data cable device according to claim 17, wherein each mating structure of the at least one set of mating structures further comprises a second mating portion located in a circumferential side of the third limiting member, and the second mating portion is located between the first mating portion and the third mating portion, the third protrusion of the second limiting member is configured to cooperate with the third mating portion and the second mating portion to drive the second limiting member to rotate, wherein the second protrusion is configured to cooperate with the third mating portion to position and lock the rotating member, or wherein the second protrusion is configured to cooperate with the first mating portion to drive the rotating member continuously rotate; the third mating portion is a third groove defined on the third limiting member, and the first mating portion is a second groove defined on the third limiting member; wherein a distance between a bottom surface of the third groove and a center of the third limiting member is greater than a distance between a bottom surface of the second groove and the center of the third limiting member; the third groove comprises a first plane and a second plane, a length of the first plane is greater than a length of the second plane; wherein the third protrusion at least abuts against the first plane to drive the third limiting member to rotate; and the second protrusion at least abuts against the first plane to limit a position of the second limiting member; and a contour shape of at least a portion of the second protrusion configured for inserting into the second groove is adapted to a contour shape of the second groove.

19. The data cable device according to claim 1, wherein the first liming member defined multiple first grooves uniformly arranged on the first limiting member; and wherein the first protrusion comprises a transmission inclined surface and a limiting plane, the transmission inclined surface is inclined toward a direction of rotation of the rotating member in a case that the first limiting member is pulled out.

20. The data cable device according to claim 1, wherein the reset assembly is an elastic assembly or a magnetic attraction assembly.
